(19) United States
(12) Patent Application Publication
(10) Pub. No.: US 2010/0091634 A1
(43) Pub. Date: Apr. 15, 2010

(54) OPTICAL HEAD DEVICE

(75) Inventors: Koichi MURATA, Chiyoda-ku (JP); Koji Miyasaka, Koriyama-shi (JP); Yukihiro Tao, Koriyama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/574,131

(22) Filed: Oct. 6, 2009

Related U.S. Application Data
(63) Continuation of application No. PCT/JP08/56812, filed on Apr. 4, 2008.

(30) Foreign Application Priority Data
Apr. 6, 2007 (JP) 2007-100785
Aug. 31, 2007 (JP) 2007-226313
Oct. 12, 2007 (JP) 2007-266594
Dec. 26, 2007 (JP) 2007-334859
Jan. 18, 2008 (JP) 2008-009506

(51) Int. Cl. G11B 7/135

(52) U.S. Cl. 369/112.23; G9B/7.112

(57) ABSTRACT

In an optical head device that subjects light exiting from a light source to reflection on an information recording layer of an optical disk, to thus guide the light to a photodetector, an optical attenuation device is disposed in an optical path from the optical disk to the photodetector, wherein the optical attenuation device has a first region having high transmissivity, a second region having low transmissivity, and a third region having an intermediate value of transmissivity, whereby light returned from a layer differing from the information recording layer, which will be responsible for crosstalk, is reduced by mean of the photodetector.

### TECHNICAL FIELD

The present invention relates to an optical head device required to subject an optical recording medium (hereinafter called an “optical disk”); for instance, a CD, a DVD, a BD, and an HD-DVD, and, more particularly, a multilayer optical disk having a plurality of information recording layers, to recording and reproduction.

### BACKGROUND ART

Optical disks include single-layer optical disks, each of which includes a single information recording layer, and multilayer optical disks, each of which has a plurality of information recording layers. For instance, when information is recorded on or reproduced from a two-layer optical disk having two recording layers, return light, which returns to a photodetector after undergoing reflection on the optical disk, is vulnerable to light reflected from adjacent information recording layers (hereinafter called “stray light”) as well as to light that is a collection of outgoing light from a light source and that is reflected by a desired information recording layer (hereinafter called “signal light”). The optical head device that subjects a multilayer optical disk to recording and reproduction must be configured so as to prevent a servo signal from undergoing the influence of a crosstalk component of the light reflected from such different recording layers. In the present specification, recording, reproduction or recording and reproduction to/from which an optical disk is to be subjected are generally expressed as “recording reproduction.”

FIG. 33 shows a schematic view of optical paths achieved when a two-layer optical disk is subjected to reproduction by an optical head device that performs recording and reproduction of data in and from a related-art multilayer optical disk. A layer close to a plane of incidence of the two-layer optical disk is taken as an L1 layer, and the other layer distant from the plane of incidence is taken as an L2 layer. For instance, provided that the L1 layer is taken as a plane 402, light received by the photodetector during reproduction is light 406. Provided that the L2 layer is taken as plane 401, reflected light is light 404. A focal point of the light 404 is situated ahead of a focal point of the light 406. Meanwhile provided that the L2 layer is taken as a plane 402, light received by the photodetector during reproduction is taken as light 406. Provided that the L1 layer is taken as a plane 403, reflected light is light 405. A focal point of the light 405 is situated behind a focal point of the light 406.

In relation to light returning from the L1 layer (a target layer) during reproduction of data from the L1 layer, the 0^{th}-order transmitted beam and the ±1^{st}-order diffracted beams respectively converge on a detection plane of the photodetector by means of diffracting action of a diffraction element. The return light reflected from the L2 layer (another layer) with reference to the L1 layer has a large beam size and low luminous density and is radiated as stray light on the detection plane of the photodetector, thereby causing interference with the return light from the L1 layer (the target layer) on the photodetector. When a change has arisen in conditions for light interference because of variations in a layer interval between information recording layers and in a wavelength of the light source, signal intensity changes, to thus cause a problem of deterioration of reading performance. In particular, an optical head device using a 3-beam method, the ±1^{st}-order diffracted beams that act as sub-beams of signal light are smaller in luminous energy than a main beam; hence, the ±1^{st}-order diffracted beams are more vulnerable to interference from stray light.

An optical head device, such as that shown in; for instance, JP-A-2005-203090 (Patent Document 1), has hitherto been put forward as countermeasures against the problem. The optical head device is for eliminating stray light in an area where the ±1^{st}-order diffracted beams, which will act as sub-beams, are radiated onto the photodetector by positioning a hologram element 410, such as that shown in FIG. 34, in a luminous flux and arranging diffraction gratings in areas 411 on the hologram element so as to diffract portions of the return light from the optical disk.

In the configuration provided in Patent Document 1, light passed through an area 412 on the hologram element 410 equipped with no diffraction gratings is guided to the photodetector at high transmissivity. Meanwhile, the light passed through the areas 411 equipped with diffraction gratings undergoes diffraction (hereinafter called “phase grating diffraction”); hence, beams in a low-transmissivity region are guided to the photodetector. However, when a high transmissivity region and a low transmissivity region are mixedly present in a luminous flux guided to the photodetector, optical intensity modulation arises in the luminous flux, and light undergoes wrap-around diffraction (hereinafter called “diffraction of intensity-modulated light”) for reasons of intensity modulation. Because of diffraction of intensity-modulated light, a sub-beam photodetector is exposed to wrapped-around stray light from another layer of the optical disk, and hence the stray light cannot be effectively eliminated. Therefore, when light from the target layer interferes with light from the other layer on the photodetector and when a change arises in the conditions for light interference for reasons of variations in a layer interval between information recording layers or the wavelength of the light source, signal intensity changes, to thus raise a problem of deterioration of reading performance. When the area of the phase grating-diffraction grating region is increased, as countermeasures against the problem, in order to prevent the stray light undergone diffraction of intensity-modulated light from arriving at the photodetector, light from the target layer from which data are originally desired to be read as well as the stray light from the other layer undergo phase grating diffraction in the hologram element, which also raises a problem of deterioration of the intensity of signal light entering the photodetector.

### DISCLOSURE OF THE INVENTION

### Problem that the Invention is to Solve

The present invention has been conceived to solve the problems in the related art and aims at providing an optical head device capable of sufficiently eliminating stray light components in a photodetector and recording and reproducing data in and from a multilayer optical disk without involvement of further deterioration of signal intensity.

### Means for Solving the Problem

To achieve the above-described object, according to the present invention, an optical head device is provided which includes:

a light source,

an objective lens that converges outgoing light from the light source on an information recording plane of an optical disk,

a photodetector having a plurality of light-receiving areas for detecting signal light reflected from the information recording plane of the optical disk, and

an optical element that is disposed in an optical path for signal light traveling from the optical disk to the photodetector and that has a function of permitting passage of the signal light or diffracting the signal light through an incidence plane while reducing a quantity of light, wherein

an effective region of the optical element where at least the signal light enters is divided into a first region, a second region, and a third region,

an outer edge of the second region is located at an interior position where the outer edge does not contact an outer edge of the third region or at an interior position where the outer edge contacts a portion of the outer edge of the third region,

an outer edge of the third region is located at an interior position where the outer edge does not contact an outer edge of the first region or at an interior position where the outer edge contacts a portion of the outer edge of the first region,

provided that a ratio of light entering the photodetector to the signal light entering the optical element is taken as transmissivity, when transmissivity of the signal light achieved in the first region is T1 and when transmissivity of the signal light achieved in the second region is T2, T1 is greater than T2,

transmissivity of the signal light achieved in the third region is smaller than T1 and greater than T2, and

at least a portion of a luminous flux of stray light that is resultant of convergence of light from the light source and that is guided to the photodetector upon reflection from a plane of an optical disk differing from the information recording plane, enters the second region of the optical element, thereby diminishing a quantity of stray light arriving at least a portion of the light receiving areas of the photodetector.

Further, when transmissivity of the signal light achieved in the third region of the optical element is uniform T3, a difference between T1 and T3 of an optical attenuation device and a difference between T3 and T2 of the optical element may range from over 0% to 60%

By means of the configuration, the third region is interposed between the first region and the second region within the plane of the optical element where light enters, whereby transmissivity smoothly changes. Therefore, the influence of wraparound of stray light attributable to diffraction of intensity-modulated light of transmitted light, which would otherwise be caused by a transmissivity distribution of the optical element, can be inhibited. In particularly, there can be provided an optical head device capable of diminishing wraparound of stray light in the photodetector that receives sub-beams and recording and reproducing data in and from a multilayer optical disk involving few interference of signal light with stray light.

Further, the third region may be divided into “m” regions R1 to Rm (an integer of m≧2), an outer edge of the region Rm is located at an interior position where the outer edge does not contact the outer edge of the first region or the interior position where the outer edge contacts a portion of the outer edge of the first region, when “x” is taken as an integer ranging from 2 to “m,” an outer edge of a region Rx−1 is located at an interior position where the outer edge does not contact an outer edge of the region Rx or at an interior position where the outer edge contacts a portion of the outer edge of the region Rx−1, an outer edge of the second region is located at an interior position where the outer edge does not contact an outer edge of the region R1 or an interior position where the outer edge contacts a portion of the outer edge of the region Rx, and when transmissivity of the signal light undergoing passage or diffraction through or in the region R1, the region R2, . . . , the region Rm is taken as Tr1, Tr2, . . . , Trm, respectively, there may stand a relationship of Tr1<Tr2< . . . <Trm.

Further, a difference between T1 and Trm of the optical element, a difference between Trx and Trx−1 of the optical element, and a difference between Tr1 and Tr2 of the optical element may range from over 0% to 40%.

Since the transmissivity distribution of light achieved from the first region to the second region smoothly changes by virtue of the configuration, diffraction of intensity-modulated light entering the optical element can further be inhibited. In particular, in an optical head device using a 3-beam method, wraparound of stray light into the photodetector that receives sub-beams can further be reduced, and there can be provided an optical head device capable of recording and reproducing information in and from a multilayer optical disk involving fewer interference of signal light with stray light. By means of a configuration, such as that mentioned above, stray light can be controlled without involvement of an increase in the second region having low transmissivity. Hence, recording and reproduction of information in and from a multilayer optical disk without involvement of a large drop in signal intensity becomes possible.

Further, the optical head device that the optical element is an optical attenuation device having a function of letting the signal light pass in a rectilinear direction while reducing a quantity of the light is provided. Further, at least the second region and the third region of the optical attenuation device may include an optical multilayer film or a cholesteric liquid crystal layer that reduces a quantity of the entering signal light.

By means of the configuration, transmissivity of incident light can be adjusted with respect to each region in the optical attenuation device. Further, a function of the optical attenuation device having a high degree of freedom can be implemented by utilization of a characteristic of transmissivity changing according to a wavelength of incident light.

Further, at least the second region and the third region of the optical attenuation device may include a diffraction grating structure that reduces rectilinearly-traveling light by diffracting the entering signal light.

By means of the configuration, transmissivity of rectilinearly-traveling light (hereinafter called “0^{th}-order transmitted light”) can be controlled by changing the diffraction grating structure on a per-region basis, and wraparound of stray light attributable to diffraction of intensity-modulated light entering the optical attenuation device can be reduced. Moreover, since the efficiency of rectilinearly-transmitting light (hereinafter called “0^{th}-order transmissivity”) can be changed by the wavelength of incident light, so that the wavelength of stray light can be selected and the stray light can be reduced.

Further, the optical element may include a modulation element that changes at least a portion of polarized state of the incident light and a polarizer that are arranged in sequence along a traveling direction of incident light, the polarizer that causes the light of first polarized state to pass and that blocks light of second polarized state orthogonal to the first polarized state, and light exiting from the first region passes through the polarizer after having been changed to light of first polarized state by the modulation element, light exiting from the second region does not pass through the polarizer as a result of being brought into the second polarized state by the modulation element, and light exiting from the third region is brought by the modulation element into a state where the first polarized state and the second polarized state are mixed whereby only light of the first polarized state is caused to pass.

By means of the configuration, light can be prevented from exiting from the second region, hence, the quantity of stray light can be significantly reduced by reducing transmissivity to substantially zero, so that interference induced by crosstalk can significantly be reduced. Light which will cause noise can also be reduced by use of a light-absorption polarizer. As will be described later, the modulation element may also be an element which changes a polarized state by means of a wavelength plate or an element which changes an angle of rotation according to a thickness by use of a polarization rotator and which converts linearly-polarized incident light into linearly-polarized light in a different direction with respect to each region, to thus let the linearly-polarized light exit.

Further, the optical element may be a hologram element having a function of diffracting at least a portion of signal light reflected from the optical disk, the first region has a diffraction grating that diffracts the signal light, the photodetector is arranged in a direction in which the signal light entering the first region is diffracted, and a ratio of the signal light received by the photodetector to the signal light entering the hologram element is taken as transmissivity.

A quantity of stray light passed through the second region, to thus arrive at the photodetector, can be reduced by means of the configuration, and generation of stray light at the photodetector for reasons of temperature dependence or variations in manufacture can be inhibited. Hence, there can be provided an optical head device additionally provided with a function of diminishing interference of stray light, which would cause noise, with signal light.

Further, a diffraction element that diffracts a portion of outgoing light from the light source to thus generate one main beam and two sub-beams may be provided, and the second region includes a beam of stray light that arrives at least a sub-beam light receiving area of the photodetector.

The stray light entering the photodetector is efficiently eliminated by the configuration. In particular, sub-beams of the signal light, which are smaller in quantity than the main beam, are vulnerable to stray light. Hence, the photodetector makes it possible to reduce interference of the sub-beams with the stray light, whereby tracking accuracy is effectively enhanced.

Further, an effective area by way of which the main beam of the signal light enters the hologram element may include the first region and the second region, and an optical axis of the main beam is included in the second region.

The interference of the stray light guided to the photodetector through diffraction with the main beam can be reduced by means of the configuration, hence, reproduction quality of information is preferably enhanced.

Further, a traveling direction of the signal light exiting from the second region may differ from a direction of the photodetector, and the transmissivity T2 substantially comes to zero.

The traveling direction of signal light exiting from the first and third regions toward the photodetector is separated from the traveling direction of signal light exiting from the second region by means of the configuration, whereby an optical head device that reduces the stray light guided to the photodetector can be implemented. A crosstalk phenomenon in the photodetector, which is interference of signal light with stray light, can greatly be reduced.

Further, the optical element may be a hologram element having a function of diffracting at least a portion of signal light reflected, in the form of a single beam, from the optical disk, a photodetector arranged in a traveling direction of diffracted light of the largest quantity of outgoing light resultant from diffraction of the signal light entering the first region of the hologram element is taken as a first photodetector, and a ratio of light received by the first photodetector is taken as transmissivity.

By means of the configuration, the third region is present, within the plane (=an effective region) of a hologram element where light enters, between the first region that is distant from an optical axis of stray light and a second region including the optical axis of the stray light, whereby transmissivity of light quantity guided as a result of diffraction of diffracted light at the photodetector smoothly changes. Hence, the influence of wraparound of stray light attributable to diffraction of intensity-modulated light of transmitted light induced by the transmissivity distribution of the hologram element can be reduced. As a result, an optical head device capable of reproducing information from a multilayer optical disk that reduces interference of signal light with stray light at a photodetector and that has a high signal-to-noise ratio can be provided. Here, one photodetector has one light receiving area, and the light receiving area is divided into a plurality of segments as will be described later.

Further, a traveling direction of the signal light exiting from the second region may differ from the direction of the first photodetector, and the transmissivity T2 substantially comes to zero.

A traveling direction of signal light entering the first region and the third region is separated from the traveling direction of signal light entering the second region by means of the configuration, whereby an optical head device that does not guide stray light to the photodetector can be embodied. A crosstalk phenomenon, which is interference of signal light with stray light, in the photodetector can greatly be reduced.

Further, the signal light entering the second region may rectilinearly travel and exit.

By virtue of the configuration, the second region does not need to assume a diffraction grating structure, and hence productivity of the hologram element is enhanced, and quality improvements can be expected.

Further, a photodetector arranged in a traveling direction of rectilinearly-passed light or diffracted light of the largest quantity of the light exiting from the second region may be taken as a second photodetector, and the first photodetector and the second photodetector receive the signal light.

Signal light exiting from the second region can be detected by means of the configuration, and hence an optical head device that achieves a high optical efficiency can be implemented.

Further, in the hologram element, an effective region by way of which the signal light enters the hologram element may be divided into the first region, the second region, the third region, the fourth region, and the fifth region, an outer edge of the first region is located at an interior position where the outer edge does not contact an outer edge of the fifth region or at an interior position where the outer edge contacts a portion of the outer edge of the fifth region, the outer edge of the fifth region is located at an interior position where the outer edge does not contact an outer edge of the fourth region or at an interior position where the outer edge contacts a portion of the outer edge of the fourth region, the first region, the third region, the fourth region, and the fifth region have diffraction gratins for diffracting at least a portion of the signal light, a photodetector arranged in a traveling direction of light of the largest quantity achieved in a direction differing from traveling directions toward the first photodetector and the second photodetector, among outgoing light beams resultant from diffraction of the signal light entering the fourth region of the hologram element, is taken as a third photodetector, provided that ratios of the signal light arriving at the first photodetector to the signal light entering the first through fifth regions of the hologram element are taken as T1, T2, T3, T4, and T5, there stand

T1>T3>T2,

T1≧T5≧T4;

provided that ratios of the signal light arriving at the third photodetector to the signal light entering the first through fifth regions of the hologram element are taken as T1′, T2′, T3′, T4′, and T5′, there stands

T4′>T5′>T1′≧T3′≧T2′; and

at least a portion of a luminous flux of stray light, which is guided to the photodetector upon reflection from a plane of the optical disk differing from the information recording plane on which light from the light source is converged, enters the second region of the hologram element.

Since stray light can be caused to arrive at the plurality of photodetectors by means of the configuration while being reduced in quality, interference of signal light for generating a plurality of types of error signals pertaining to reproduction with stray light can be reduced, whereby a reduction in the influence of crosstalk and an improvement in reproduction quality are achieved.

Further, the diffraction grating structure of the hologram element may include at least a structure of blaze shape.

By means of the configuration, light can be diffracted in high intensity in only one diffracting direction, and hence an optical efficiency is enhanced.

Further, the diffraction grating of the hologram element may be made of a birefringent material exhibiting refractive anisotropy and an isotropic material exhibiting a refractive index substantially equal to an ordinary refractive index or an extraordinary refractive index of the birefringent material.

Even when a hologram element is placed in an optical path shared between an optical path from a light source of an optical head device to an optical disk (hereinafter called a “forward path”) and an optical path from the optical disk to a photodetector (hereinafter called a “return path”), substantially all of light in the forward path is caused to pass, and light in the return path (=return light) is diffracted, whereby the quantity of light can be controlled. Hence, light in the forward path can efficiently be guided to the optical disk. The degree of layout freedom of the hologram element is also enhanced.

### ADVANTAGE OF THE INVENTION

The present invention can provide an optical head device that yields an effect of the ability to sufficiently eliminate stray light components in a photodetector and record and reproduce data in and from a multilayer optical disk without involvement of further deterioration of signal intensity.

### BRIEF DESCRIPTION OF THE DRAWINGS

FIG. 1 is a conceptual configuration diagram of an optical head device having an optical attenuation device of the present invention;

FIGS. 2A to 2D are schematic plan views of the optical attenuation device of a first embodiment of the present invention;

FIGS. 3A and 3B are graphs showing transmissivity distributions achieved, in a third region of the optical attenuation device shown in FIGS. 2A to 2D and 5A and 5B and a third region of a hologram element shown in FIGS. 14A and 14B;

FIGS. 4A to 4C are schematic cross-sectional views of optical paths passing through the optical attenuation devices;

FIGS. 5A and 5B are schematic plan views of an optical attenuation device of a second embodiment of the present invention;

FIG. 6 is a schematic cross-sectional view of the optical attenuation device formed from an optical multilayer film;

FIG. 7 is a schematic cross-sectional view of the optical attenuation device formed from a cholesteric liquid crystal material;

FIGS. 8A and 8B are schematic cross-sectional views of an optical attenuation device exhibiting diffracting action;

FIG. 9 is a schematic view showing a light-received state of a photodetector achieved when the optical attenuation device is used;

FIGS. 10A and 10B are a schematic plan view of a polarizer and a schematic cross-sectional view of an optical attenuation device of a third embodiment of the present invention;

FIG. 11 is a conceptual schematic view of an optical head device equipped with a hologram element of the present invention;

FIGS. 12A to 12D are schematic plan views of a hologram element of a fourth embodiment of the present invention;

FIGS. 13A to 13C are schematic cross-sectional views of an optical path for light passing through (undergoing diffraction in) the hologram element;

FIGS. 14A and 14B are schematic plan views of a hologram element of a fifth embodiment of the present invention;

FIGS. 15A and 15B are schematic cross-sectional views of a hologram element exhibiting diffracting action;

FIG. 16 is a schematic view showing a light-received state of a photodetector achieved when the hologram element is used;

FIG. 17 is a conceptual configuration diagram of another optical head device equipped with a hologram element of the present invention;

FIGS. 18A to 18D are schematic plan views of a hologram element of a sixth embodiment of the present invention;

FIGS. 19A and 19B are schematic plan views of a hologram element of a seventh embodiment of the present invention;

FIGS. 20A and 20B are schematic cross-sectional views of a hologram element exhibiting diffracting action;

FIG. 21 is a schematic view showing a light-received state of a photodetector achieved when the hologram element shown in FIGS. 18A to 18D are used;

FIG. 22 is a schematic plan view of a hologram element of an eighth embodiment of the present invention;

FIG. 23 is a schematic view showing a light-received state of a photodetector achieved when the hologram element shown in FIG. 22 is used;

FIG. 24 is a schematic plan view of a hologram element of a modification of the eighth embodiment of the present invention;

FIG. 25 is a schematic view showing a light-received state of a photodetector achieved when the hologram element shown in FIG. 24 is used;

FIG. 26 is a schematic plan view of a hologram element of a ninth embodiment of the present invention;

FIG. 27 is a schematic view showing a light-received state of a photodetector achieved when the hologram element shown in FIG. 26 is used;

FIG. 28 is a graph showing the intensity distribution of stray light received by the photodetector when the optical attenuation device of the present invention is used;

FIG. 29 is a schematic plan view of the optical attenuation device acting as a comparative example;

FIG. 30 is a graph showing the intensity distribution of stray light received by the photodetector when the optical attenuation device shown in FIG. 29 is used;

FIG. 31 is a graph showing a comparison between intensity distributions of light received in sub-beam receiving areas when the optical attenuation devices shown in FIGS. 5A, 5B and 29 are used;

FIG. 32 is a graph showing an intensity distribution of stray light achieved on the photodetector when the hologram element of the present invention is used;

FIG. 33 is a schematic view showing optical paths achieved during reproduction of data from two-layer optical disk; and

FIG. 34 is a schematic plan view of a related-art diffraction element.

### BEST MODE FOR IMPLEMENTING THE INVENTION

An optical element of the present invention is used for relatively reducing stray light when compared with signal light traveling for a photodetector. Specifically, the optical element includes a diffraction grating, a hologram element, a polarizing plate, a semi-transparent reflection plate, a colored plate, and the like. The essential requirement for the case of a diffraction grating and a hologram element is that the optical element should be designed and arranged so as to use linear transmitted light (the 0^{th}-order diffracted light) or the 1^{st}-order or more diffracted light. The essential requirement for the case of a polarizing plate is that the optical element should be designed and arranged by adjusting the polarizing direction of return light and a polarization axis of the polarizing plate. The essential requirement for the case of a semi-transparent reflection plate and a colored plate is that the optical element must be designed and arranged so as to use reflected light or linear transmitted light. Even when combined with each or combined with a phase plate, the optical elements can be used. Transmissivity achieved in each region means transmissivity of light traveling to photodetector (a first photodetector in a case where a plurality of photodetectors are used). Therefore, when linear transmitted light is optically detected, transmissivity means transmissivity of linear transmitted light. When diffracted light is optically detected, transmissivity means transmissivity of diffracted light. Specific descriptions are provided by illustration of an example of transmissivity.

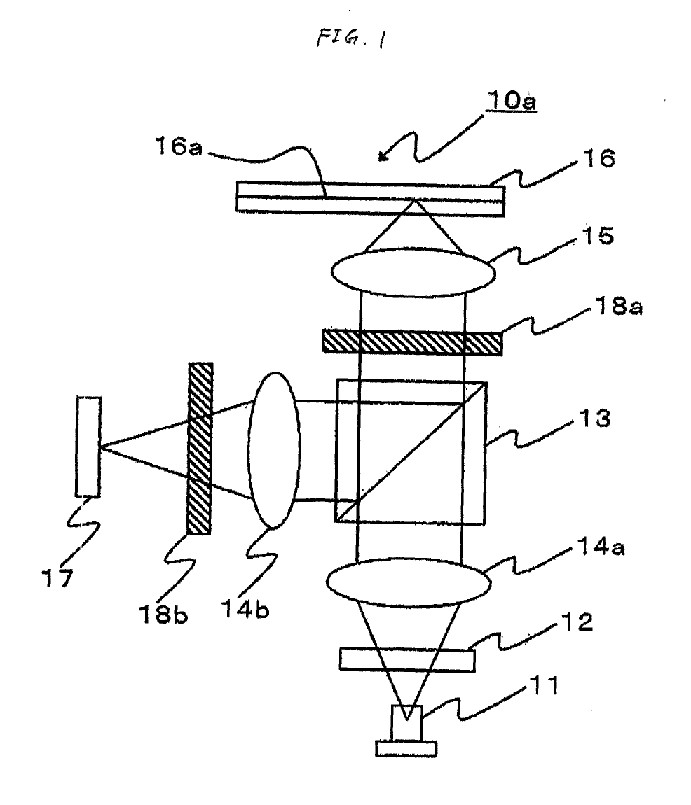

FIG. 1 is a view showing a conceptual configuration of an optical head device 10a equipped with an optical attenuation device of the present invention. The optical head device 10a has a light source 11 from which a luminous flux of predetermined wavelength exits; a diffraction element 12 that diffracts a portion of the outgoing luminous flux from the light source 11, thereby generating three beams; namely, one main beam and two sub-beams; a collimator lens 14a that collimates the incident luminous flux into collimated light; a beam splitter 13 that causes the three beams output from the collimator lens 14a to pass toward an optical disk 16 and that subjects return light of the three beams reflected by an information recording plane 16a of the optical disk 16 to deflection and separation, thereby guiding the thus-deflected, separated beams to a photodetector 17; an objective lens 15 that collects the three beams on the information recording plane 16a of the optical disk 16; a collimator lens 14b that collects return light of the three beams to the photodetector 17; the photodetector 17 that detects the return light of the three beams; and an optical attenuation device 18a or 18b.

The optical attenuation device of the present invention is placed at a position where a single optical path works as a forward path and a return path or in a return path when a forward path is different from the return path. FIG. 1 shows an example in which the optical attenuation device 18b is placed in an optical path acting solely as a return path, and in which the optical attenuation device 18a is arranged in an optical path common to the forward path and the return path. The optical attenuation device is not limited to a configuration in which the element is placed in two optical paths, but can also be placed in only one of the optical paths.

The photodetector 17 detects a read signal pertaining to information recorded in the information recording plane 16a, which is to be subjected to reproduction, of the optical disk 16, a focus error signal, and a tracking error signal. The optical head device 10a has an unillustrated focus servo that controls a lens in a direction of its optical axis in accordance with a focus error signal and an unillustrated tracking servo that controls the lens in a direction substantially perpendicular to the optical axis in accordance with the tracking error signal.

The light source 11 is made up of a semiconductor laser that emits a divergent luminous flux of a linear polarized beam at a waveband of; for example, 650 nm. The light source 11 employed in the present invention is not limited to light having a waveband of 650 nm but can also be; for instance, light at a waveband of 400 nm, light at a waveband of 780 nm, and light at another waveband. Here, the waveband of 400 nm is set so as to fall within a range from 385 nm to 430 nm; the waveband of 650 nm is set so as to fall within a range from 630 nm to 690 nm; and the waveband of 780 nm is set so as to fall within a range from 760 nm to 800 nm.

The light source 11 can also be configured so as to emit luminous fluxes having two or three types of wavelengths. The light source of such a configuration can be a so-called hybrid two-wavelength laser light source or a three-wavelength laser light source including two or three semiconductor laser chips mounted on a single substrate; or a monolithic two-wavelength laser light source or a three-wavelength laser light source having two or three luminous points which emit beams having mutually-different wavelengths.

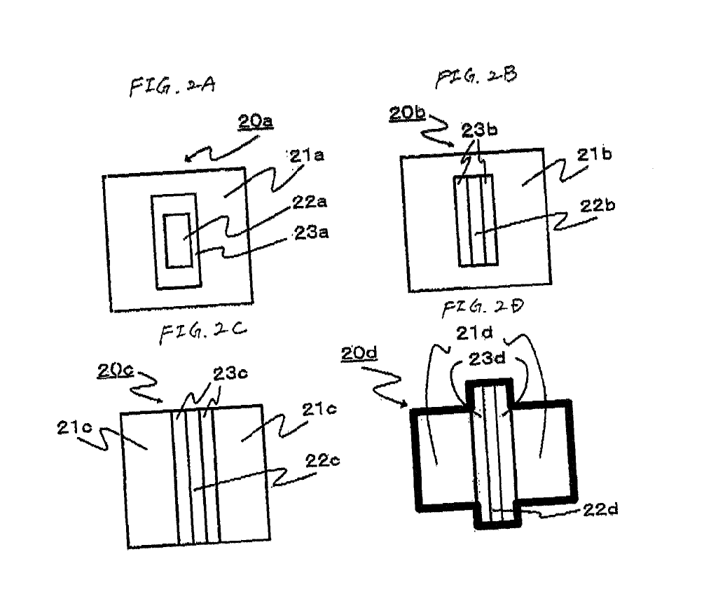

FIGS. 2A, 2B, 2C, and 2D show respective schematic plan views of optical attenuation devices 20a, 20b, 20c, and 20d of the first embodiment. The optical attenuation device 20a is divided into a first region 21a including an outer frame of the optical attenuation device; a third region 23a located inside an outer edge of the first region 21a; and a second region 22a located inside an outer edge of the third region. The word “outer edge” used herein means the outermost interface of a region. The outer edge of the second region does not always need to locate inside the outer edge of the third region. As shown in FIGS. 2B and 2C, the outer edges of the second and third regions may adjoin to each other. Further, as shown in FIG. 2B, even when outer edges of the second region 22b adjoin to two discontinuous portions of the outer edges of the third region 23b, thereby separating the third region into two divided regions, the two divided regions are assumed to be collectively taken as the third region 23b, and the outer edges of the third region are assumed to be unambiguously determined. In FIG. 2C, even when a second region 22c and third regions 23c adjoin two locations of outer edges of the first regions 21c, the outer edges are likewise assumed to be unambiguously determined. Even in an example shown in FIG. 2D, first regions 21d are a combination of two regions. Outer edges of the first regions are assumed to be unambiguously determined as indicated by a thick line including portions of outer edges of second regions 22d and portions of outer edges of third regions 23d.

Given that transmissivity of light passing through the first region is taken as T1; that transmissivity of light passing through the second region is taken as T2; and that transmissivity of light passing through the third region is taken as T3, a relationship of T1>T3>T2 is set. In particular, it is preferable to set transmissivity in such a way that a difference between T1 and T2 becomes greater, because stray light passing through the optical attenuation device is reduced. Transmissivity of each of the regions can be adjusted by utilization of characteristics of light, such as absorption, reflection, and diffraction, or combinations thereof. As will be described later, light to be received by the photodetector is not limited to light linearly passing through an optical attenuation device. In the case of an optical attenuation device having a diffraction grating structure, the +1^{st}-order diffracted light exhibiting different diffraction efficiency, for instance, can also be received in each region. In this case, since the +1^{st}-order diffraction efficiency corresponds to the foregoing transmissivity, transmissivity is assumed to include diffraction efficiency in the optical system in which the photodetector receives diffracted light. Likewise, when the photodetector receives the foregoing the 0^{th}-order transmitted light, the 0^{th}-order transmissivity is also included in the transmissivity.

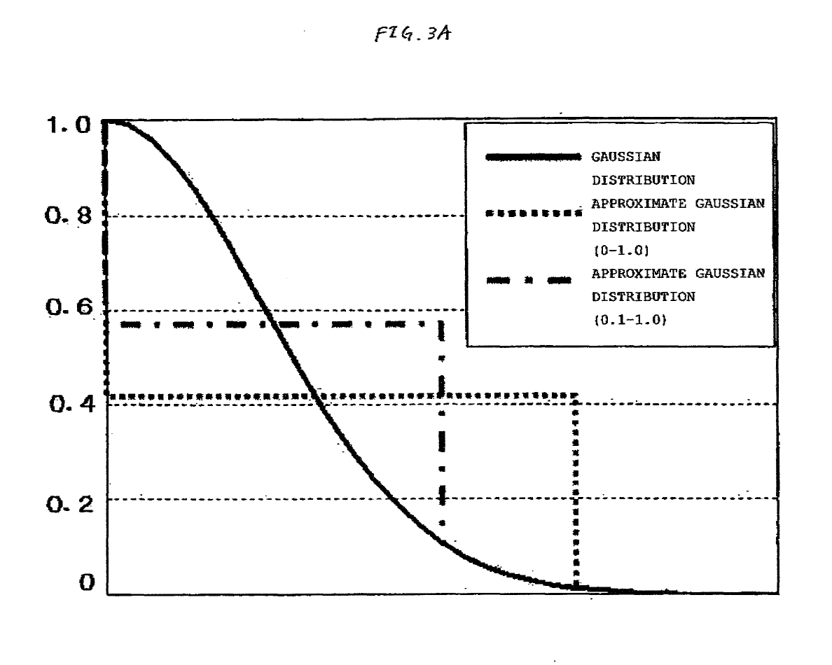

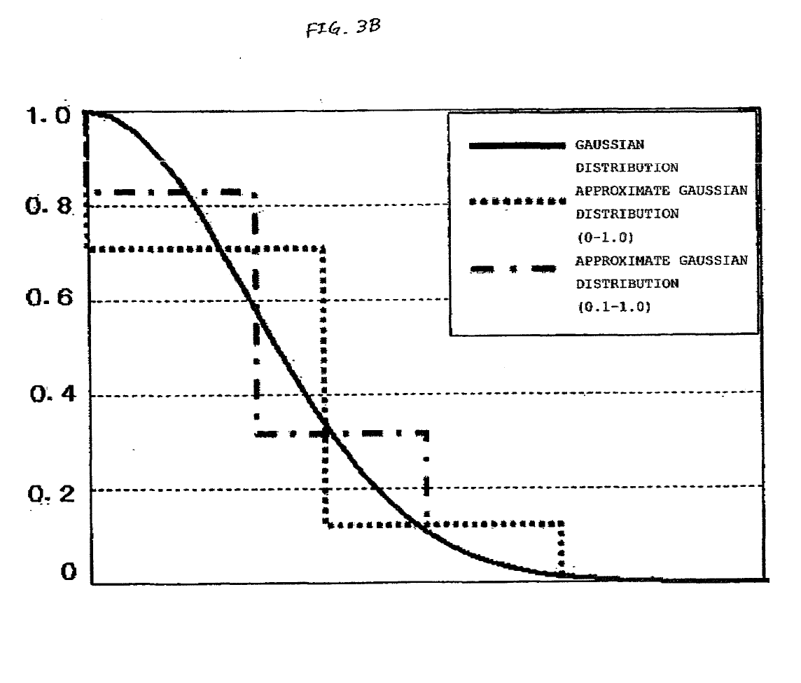

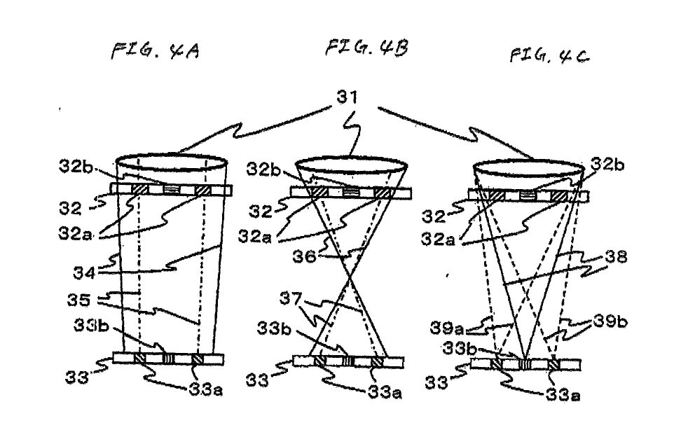

When transmissivity smoothly changes within a plane of the optical attenuation device from the first region to the third region and further to the second region like a Gaussian distribution, diffraction of intensity-modulated light is inhibited, so that a signal-to-noise ratio of signal light to stray light can be preferably increased. In the first embodiment, the third region is configured so as to assume substantially-uniform transmissivity. However, it is more preferable to configure the third region so as to assume consecutive changes in transmissivity as in the case with a Gaussian distribution. Sven when the transmissivity of the third region is substantially uniform, diffraction of intensity-modulated light can be inhibited, so long as the transmissivity is made analogous to a Gaussian distribution. FIG. 3A shows a graph of transmissivity changes achieved by the configuration of the first embodiment. An X axis represents an arbitrary linear distance to the second region on condition that the interface between the first region and the third region is taken as a point of origin (X=0). A X axis represents a transmissivity distribution of the third region achieved when T1 is normalized (=1). A solid line represents a Gaussian distribution; a dotted line represents an approximate Gaussian distribution of T3/T1 achieved when T2/T1=0; and a dashed line represents an approximate Gaussian distribution of T3/T1 achieved when T2/T1=0.1. The approximation is calculated by averaging the Gaussian distribution. Sufficient attenuation of stray light is hindered by an increase in T2/T1. For this reason, a value of 0.1 is taken as an upper limit in such a way that stray light arriving at the photodetector comes to 10% or less when compared with at least a case where the optical attenuation device is not inserted. In this configuration, if transmissivity is designed so as to fall within a range of 0.3≦T3/T1≦0.7 when T2/T1≦0.1, it is preferable that transmissivity can be caused to approximate to the Gaussian distribution. Hence, it is more preferable that transmissivity will fall within a range of 0.4≦T3/T1≦0.6.

For instance, it is preferable that signal light can be efficiently guided to the photodetector by designing transmissivity in such a way that T1 comes to 80% or more; hence, transmissivity is preferably be set to 90% or more. Since the second area eliminates stray light which will arrive at the photodetector, the quantity of stray light can be reduced to one-half or less by designing that T2 is 50% or less. In order to substantially block stray light, it is preferable to design transmissivity in such a way that T2 substantially comes to 0%. However, when a difference between T1 and T3 and a difference between T3 and T2 are large, diffraction of intensity-modulated light becomes great at an interface between the regions. Hence, T2 is preferably 60% or less in such a way that stray light does not cause a wraparound in the photodetector. Transmissivity T3 of the third region is preferably designed so as to fall between the transmissivity T1 of the first region and the transmissivity T2 of the second region; more preferably, to assume a substantially-intermediate value.

Although the optical attenuation device of the embodiment has been described in connection with the optical head device compliant with the 3-beam method, the optical attenuation device can naturally be applied to a mono-beam optical head device, as well. In any of the methods, an effective region that is a region where signal light enters the optical attenuation device includes at least the first region. The effective region is a region where light intensity comes to 10% or more the maximum light intensity of the incident signal light. As the proportion of the area of the first region occupying the effective region that is to serve as a region where signal light enters the optical attenuation device becomes greater, an optical efficiency also increases without decreasing the quantity of signal light converging on the photodetector. Therefore, it is preferable to adopt a design in which the first region accounts for 70% or more of the area of the effective region. In order to prevent occurrence of a great reduction in optical efficiency, the second region is required to have an area that is smaller than 30% of at least of the effective region. If the area of the second region is made too smaller than the area of the effective region, stray light will arrive, without being reduced, at the position on which the signal light converges for reasons of fluctuations in optical axis, which may deteriorate the signal-to-noise ratio. Therefore, the minimum requirement is that a ratio of the area of the second region to the area of the effective region must be 1% or more, in consideration of the range.

As mentioned above, the third region having intermediate transmissivity is provided between the second region having low transmissivity and the first region having high transmissivity, whereby variations of transmissivity arising in the interface between the regions can be diminished. Therefore, diffraction of intensity-modulated transmitted light, which would otherwise be caused by the distribution of transmissivity of the optical attenuation device, can be prevented. A wrap-around of stray light on the photodetector that receives sub-beams can thereby be reduced, and hence interference between signal light and stray light can be prevented.

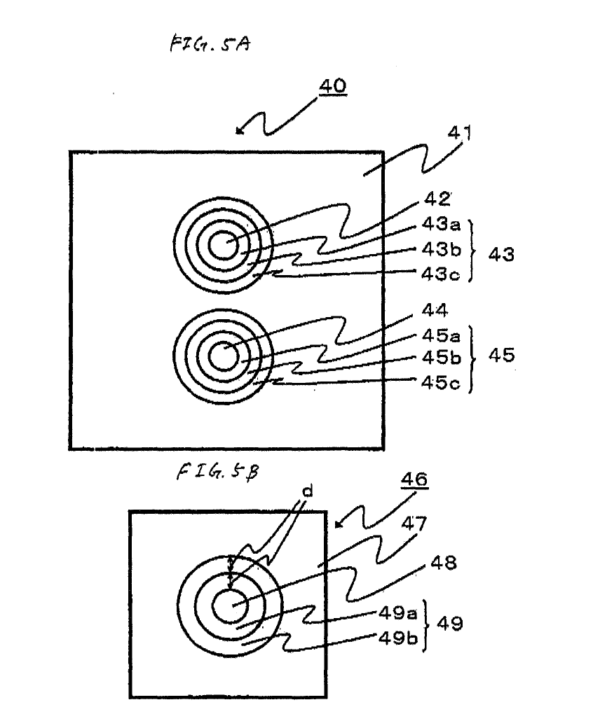

The layout of the optical attenuation device will now be described. FIGS. 4A to 4C shows schematic cross-sectional views of the state of light achieved when the optical attenuation device 32 is disposed in an optical path between the collimator lens 31 and the photodetector 33. FIGS. 4A and 4B respectively show states of stray light that does not converge to the photodetector, and FIG. 4C shows a converged state of signal light. The optical attenuation device 32 has three separated second regions 32a and 32b. An unillustrated third region is assumed to be present around each of the second regions. Reference numeral 32a designates a second region for sub-beams as will be described later, and reference numeral 32b designates a second region for a main beam. The photodetector 33 has a light receiving area 33a for sub-beams and a light receiving area 33b for a main beam.

Stray light that does not come into a focus on the photodetector 33 is first described. In FIG. 4A, stray light 34 whose focal point is located behind the photodetector arrives at the photodetector 33 without being much collected in the optical path. A beam 35 of stray light passing through the center of the second region 32a is indicated by a dashed line. The beam 35 is guided to the center of the light receiving area 33a. In FIG. 4B, stray light 36 whose foal point is located in front of the photodetector arrives at the photodetector 33 while the width of light becomes spread. A beam 36 of stray light passing through the center of the second region 32a is then indicated by a dashed line, and the beam 36 is likewise guided to the center of the light receiving area 33a. When the second region 32b is provided for a main beam, it is better to cause the second region 32b to include an optical axis of a main beam and to focus light on the light receiving area 33b for a main beam. It is much better to align the optical axis with the center of the second region 32b and the center of the light receiving area 33b.

As a result of the stray light passing through the second region of the optical attenuation device being guided to the light receiving area 33a for a sub-beam as mentioned above, the stray light arrives at the light receiving area while stray light is reduced. Further, stray light can be effectively diminished by presence of the third region. Stray light is generated by reflection of the main beam and the sub-beams from the optical recording medium. However, the stray light does not converge on the photodetector, and stray light of the sub-beams is lower than the quantity of stray light of the main beam in terms of intensity. Therefore, the majority of stray light can be considered to be reflected light of the main beam. Moreover, when the shape of the light receiving area and the shape of the second region are analogous to each other in terms of an outer edge, an optical efficiency becomes preferably large. FIG. 4C shows a collected state of signal light. Respective sub-beams 39a and 39b converge on and are guided to the light receiving areas 33a for sub-beams, and the main beam 38 converges on and is guided to the light receiving area 33b for a main beam.

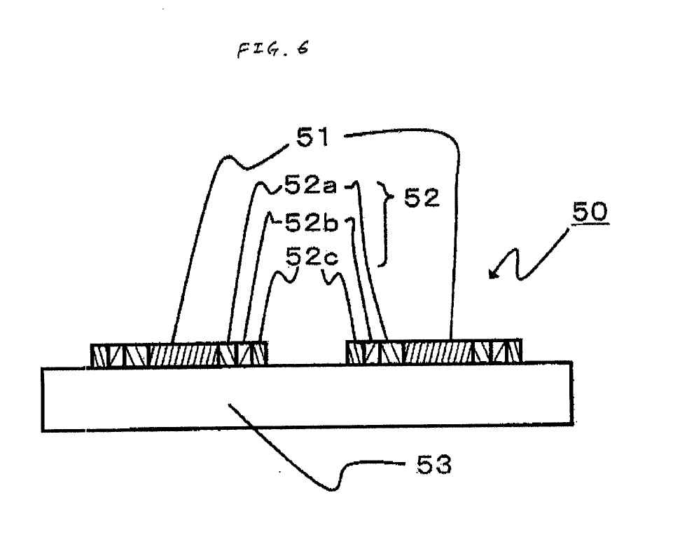

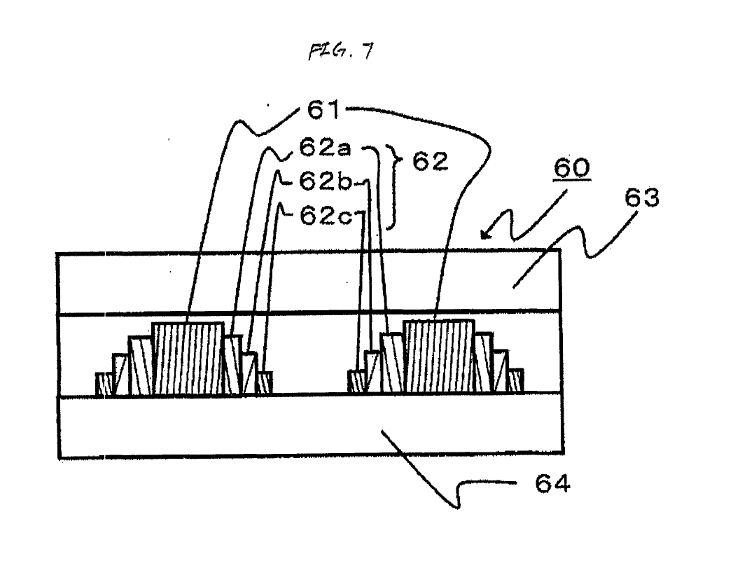

FIG. 5A shows a schematic plan view, as a second embodiment, an example optical attenuation device in which the third region is further divided into a plurality of divided regions. An optical attenuation device 40 shown in FIG. 5A is divided into a first: region 41 having high transmissivity; two second regions 42 and 44; and two third regions 43 and 45. The third regions 43 and 45 are also built from additional three divided regions; namely, 43a, 43b, 43c and 45a, 45b, 45c, respectively. The number of divided regions into which the third region is to be separated is not limited to three and can be two or four or more, and the third regions can also have a distribution of transmissivity that continuously changes from the transmissivity of the first region to the transmissivity of the second region. In the present example, the optical attenuation device is an optical attenuation device that sets two second regions in agreement with two sub-beams diffracted by the 3-beam method. The present embodiment is not limited to the configuration of regions in which the second regions and, the third regions are concentrically distributed but can also adopt a shape including a polygon or an arbitrary curve. Further, an outer edge of each of the regions can also adjoin an outer edge of another region. The second embodiment is directed toward the configuration of the optical attenuation device that works on the sub-beams vulnerable to crosstalk induced by stray light, but can also adopt the configuration of an optical attenuation device having a similar region even for a main beam.

Transmissivity of the first region 41 is taken as T1, and transmissivity of the second regions 42 and 44 is taken as T2. Further, transmissivity of the third regions 43a, 45a is taken as Tr1; transmissivity of the regions 43b, 45b is taken as Tr2; and transmissivity of the regions 43c, 45c is taken as Tr3 provided that a relationship of transmissivity achieved on the conditions is T1>Tr3>Tr2>Tr1>T2, transmissivity becomes greater stepwise toward outer edges with reference to the region 2, whereby diffraction of intensity-modulated stray light, which would otherwise arise in an interface between regions, can preferably be prevented. So long as transmissivity is designed in such a way that transmissivity is finely changed in a stepwise manner by additionally dividing the third regions or such that transmissivity is continuously changed, an inhibition effect will be further enhanced.

A method for setting a value of transmissivity difference between regions having different transmissivity values when the third region is split into a plurality of divided regions will now be described by reference to FIG. 53. For instance, an optical attenuation device 46 is divided into divided regions, such as those shown in FIG. 53. The third region 49 is separated into divided regions 49a and 49b, and the divided regions are assumed to have the same width “d.” FIG. 3B shows a graph of changes in transmissivity achieved when the third region is divided into two divided regions. An X axis represents an arbitrary linear distance to an interface between the second region 48 and the region 49a on condition that the interface between the first region 47 and the region 49b is taken as a point of origin (X=0). A Y axis represents a transmissivity distribution of the third region achieved when T1 is normalized (=1). A solid line represents a Gaussian distribution; a dotted line represents an approximate Gaussian distribution of the third region achieved when T2/T1=0 is attained; and a dashed-line represents an approximate Gaussian distribution of the third region normalized when T2/T1=0.1 is attained. The approximations are computed by averaging the Gaussian distribution. In the configuration, when T2/T1≦0.1 is attained, the maximum normalized value of transmissivity difference between regions having different transmissivity values is 0.6=(Tr2−Tr1)/T1. Therefore, it is preferable to set a normalized transmissivity difference between regions having different transmissivity values with one interface therebetween to a value ranging from over 0 to 0.7; more preferably, a value ranging from over 0 to 0.6. Further, when the third region is divided into three or more divided regions in such a way that transmissivity changes stepwise, a normalized transmissivity difference can be made smaller than 0.6 with an increase in the number of divided regions into which the third regions is separated, and the changes more approximate to the change in Gaussian distribution.

So long as transmissivity differences T1−Tr3, Tr3−Tr2, Tr2−Tr1, Tr1−T2 are set to a value of 40% or less, it is preferable to be able to further prevent diffraction, which would otherwise be caused by transmissivity difference between regions.

A specific configuration for causing the optical attenuation device common to both the first and second embodiments to act will now be described. FIG. 6 shows a schematic cross-sectional view of an optical attenuation device 50 in which respective regions are made of optical multilayer films exhibiting optical reflection. FIG. 6 is a schematic cross-sectional view cut along a linear line passing through the point of center of the two second regions in connection with the schematic plan view of FIG. 5A. The same also applies to schematic cross-sectional views provided below. In this case, a second region 51 and three divided regions 52a, 52b, and 52c making up a third region 52 are made of multilayer films stepwise exhibiting different transmissivity by means of reflection. As mentioned above, transmissivity is designed in such a way that the second region exhibits the lowest transmissivity and such that higher transmissivity is exhibited in areas that are located outer with reference to the second region. Put another way, the second region exhibits the highest reflectance, and regions located outside the second region exhibit lower reflectance.

The optical multilayer film can be made of an inorganic oxide, a fluoride, and a nitride, such as Si, Ta, Nb, Ti, Ca, and Mg, or an organic material. Reflectance can be preferably changed by changing a multilayer structure, such as the thickness of the material, with respect to each region. In order to set a light-shielded region where transmissivity is nearly 0%, metal such as Al and Cr, or a Cr oxide, can also be used. Moreover, the multilayer film is not limited to a structure where a film is stacked into layers on a glass substrate 53, but may also be formed from a translucent material, such as a plastic resin. A protective film, or the like, may also be laid over the multilayer film in order to enhance reliability. Further, the optical multilayer film can also be formed from a monolayer light-shielding film, such as a colored film.

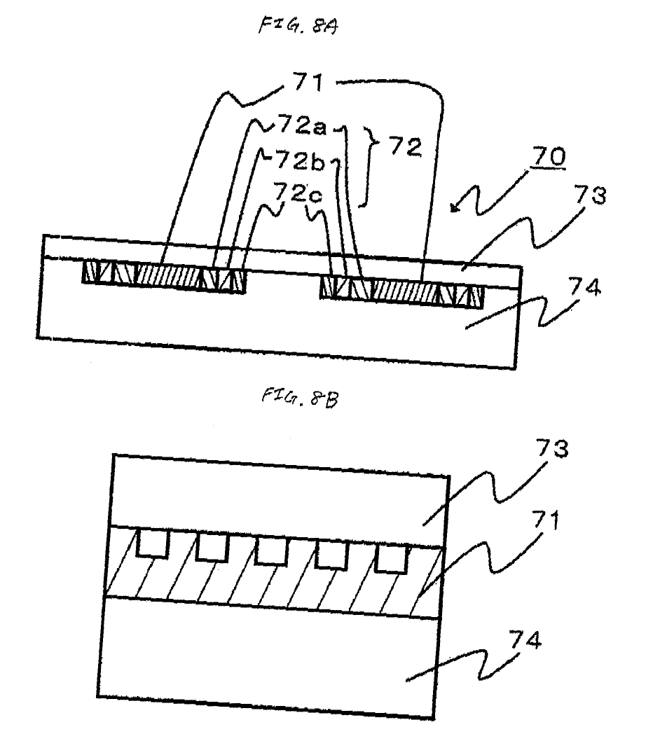

FIG. 7 shows a schematic cross-sectional view of an optical attenuation device 60 in which each of the regions is formed from cholesteric phase liquid crystal having a light-reflecting action. Cholesteric phase liquid crystal molecules are in a continuously-rotational state along a helical axis parallel to the thicknesswise direction of the optical attenuation device. It is preferable to use cholesteric phase polymer liquid crystal that is solidified upon exposure to Ultraviolet radiation with liquid crystal molecules in a helical fashion as mentioned above.

Light-reflecting action of the cholesteric phase liquid crystal is now described. Cholesteric phase liquid crystal molecules exhibit a helical characteristic and become uniformly helical in a thicknesswise direction of substrates when injected into a gap between the two uniformly-oriented, mutually-opposed substrates. When a helical pitch P is substantially equal to the product of the wavelength % of incident light and a refractive index “n” of cholesteric phase liquid crystal, cholesteric phase liquid crystal exhibits circularly polarized light depend on substantially reflecting, of incident light parallel to the direction of a helical axis, circularly polarized light assuming a rotational direction identical with a twist direction of liquid crystal molecules and substantially permitting passage of circular polarized light having an opposite rotational direction. The center wavelength λc of a waveband exhibiting the reflection characteristic is represented by a relationship of Equation (1), provided that a helical pitch is P, an ordinary refractive index of liquid crystal is “no,” and an extraordinary refractive index is “ne.” Moreover, a reflection bandwidth Δλ is expressed by a relationship of Equation (2). (λc±Δλ) is hereunder defined as a reflection waveband.

[Mathematical Expression 1]

Δc=(no+ne)/2×P (1)

Δλ=(ne−no)×P (2)

When circularly polarized light, which will assume a rotational direction in the same twist direction as that of liquid crystal molecules within a reflection waveband, enters the optical attenuation device, the light undergoes reflection in a cholesteric phase polymer liquid crystal layer. Moreover, when light whose wavelength is different from the (λc±Δλ) reflection waveband enters the optical attenuation device, the device exhibits a characteristic of permitting passage of even a circular polarized beam which will assume a rotational direction in the same twist direction of the liquid crystal molecule.

The optical attenuation device 60 shown in FIG. 7 includes a second region 61 and three divided regions 62a, 62b, and 62c that make up the third region 62, wherein the respective regions are made of cholesteric phase polymer liquid crystals that exhibit different transmissivity values through their reflecting actions. Liquid crystal molecules of all of the regions are identical with each other in terms of the helical direction and the helical pitch P; however, the respective regions differ from each other in terms of a thickness. In this case, reflectance increases as thickness increases. Therefore, the distribution of transmissivity is designed in such a way that thickness is increased in order of the third region 62 and the second region and also in order of the regions 62c, 62b, and 62a even in the third region 62. When the optical attenuation device 60 is sandwiched between mutually-opposed glass substrates 63 and 64, the reliability of the optical attenuation device 60 is preferably enhanced. When a space corresponding to the first region is filled with a translucent material, transmissivity is preferably enhanced.

When the optical attenuation device 60 using cholesteric phase Liquid crystal is taken as the optical attenuation device 18a of the optical, head device 10a shown in FIG. 1, a quarter wavelength plate (not shown) that converts polarization of light, which has exited from the light source 11 and is traveling toward the optical disk 16 along the forward path, into circular polarization is disposed in an optical path between the optical attenuation device 18a and the beam splitter 13. Cholesteric phase liquid crystal is arranged so as to exhibit high transmissivity in all regions with respect to the circularly-polarized light of the forward path. By virtue of such an arrangement, the light in the return path reflected from the optical disk 16 comes into circularly polarized light that rotates in an opposite direction as compared with the circularly polarized light in the forward path, and the light passes through the optical attenuation device 18a while the quantity of light is changed by transmittance (reflectance) that differs with respect to each region. Therefore, an optical attenuation device that exhibits high transmittance for light in the forward path and that exhibits different reflectance (different transmissivity) for light in the return path according to a region can be materialized. Even when the optical attenuation device is placed in an optical path shared between the forward path and the return path, light in the forward path can be efficiently, preferably guided to an optical disk.

In an optical head device that uses two types of wavelengths of light; for instance, one wavelength of light is for a monolayer optical disk, and the other wavelength of light is for a multilayer optical disk, the reflection waveband of cholesteric phase liquid crystal of the optical attenuation device 60 is set so as to include the wavelength for a multilayer optical disk. Nearly 100% of light, which has a wavelength for a monolayer optical disk and which is less vulnerable to crosstalk, is caused to pass, whereby a wavelength-selective optical attenuation device is realized, so that an optical head device having a high degree of flexibility can be configured.

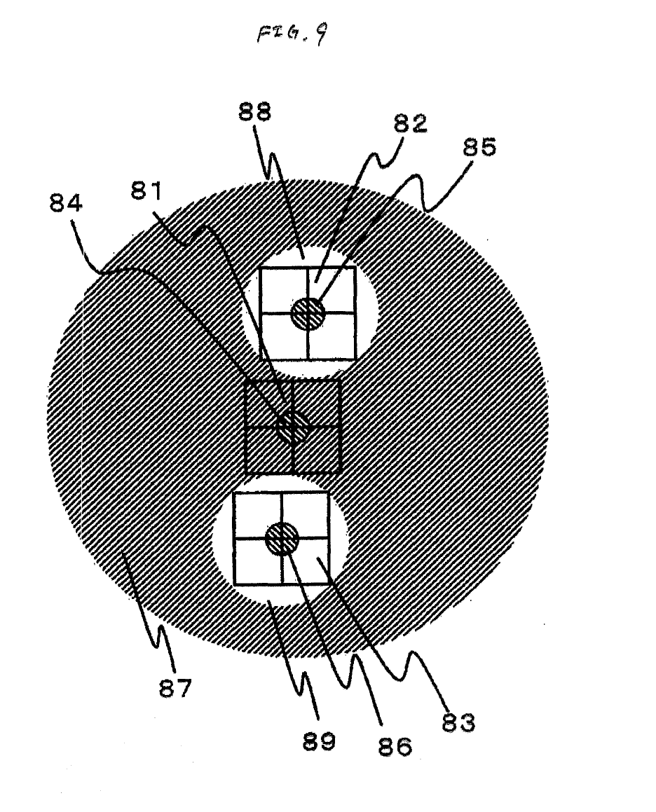

An optical attenuation device made up of regions exhibiting light diffracting action is now described and the optical attenuation device by use of a schematic cross-sectional view of FIG. 8A. In an optical attenuation device 70 shown in FIG. 8A, a second region 71 and three divided regions 72a, 72b, and 72c making up a third region 72 each have a diffraction grating structure that is formed on a surface of each of the regions and that has periodic indentations and protrusions. In each of the regions, the 0^{th}-order transmissivity of incident light can be changed by utilization of a different diffraction characteristic determined by a diffraction grating with periodic indentations and protrusions. The 0^{th}-order transmissivity is designed, at this time, so as to become greater in sequence from the second region, the third region, and the first region.

The 0^{th}-order transmissivity of light entering the diffraction grating structure of each of the regions can be adjusted by changing the depth of the indentations of the diffraction grating structure made in the surface of each of the regions or the refractive index of a material for a convexoconcave grating. Moreover, transmissivity can also be realized by changing a ratio (a Duty ratio) of width of indentations and projections in a grating, or changing a combination of a depth, a material, and others. Moreover, the structure of the diffraction grating is not limited to a rectangular cross sectional profile. The diffraction grating can also assume any structure, such as a saw-toothed shape, so long as the 0^{th}-order transmissivity is changed by means of diffracting action.

When a grating is fabricated by means of photolithography, the duty ratio can be realized by changing the width of an opening in a grating of a photomask with respect to each region, and can be preferably realized at low cost. Further, under the method for changing the depth of a grating or the method for changing a material for a grating, it is preferable even when difficulty is encountered in view of restrictions on a process for reasons of a very small line width, such as a case where a grating with a fine pitch is fabricated, the grating can be fabricated by changing the duty ratio. FIG. 8B shows an enlarged schematic view of the cross section shown in FIG. 8A. Each of the regions is preferably made of a material exhibiting birefringence, and a convexoconcave structure on a surface is preferably filled with a material 73, which is substantially equal to a birefringent material in terms of an ordinary refractive index (no) or an extraordinary refractive index (ne), and planarized.

When the optical attenuation device 70 is taken as the optical attenuation device 18a of the optical head device 10a shown in FIG. 1, the quarter wavelength plate (not shown) that converts polarization of light in the forward path, which has exited from the light source 11 and travels toward the optical disk 16, into circularly polarized light is positioned at an optical path between the optical attenuation device 18a and the objective lens 15. The optical attenuation device 18a is arranged at this time in such a way that high transmissivity is exhibited in all of the regions with respect to the linearly polarized light in the forward path. Meanwhile, the light in the return path, which has been reflected by the optical disk 16, passes through the unillustrated quarter wavelength plate and subsequently turns into linearly polarized light that is orthogonal to the linearly polarized light in the forward path. The linearly polarized light rectilinearly passes through the optical attenuation device 18a while the quantity of light is changed by the 0^{th}-order transmissivity that changes with respect to each region in the optical attenuation device lea. Therefore, even when the optical attenuation device is placed in an optical path that is shared between the forward path and the return path, the light in the forward path can preferably be guided to the optical disk with superior efficiency.

Although the 0^{th}-order transmissivity has been described as the characteristic of the diffraction grating structure, the photodetector can also be placed in the optical path for diffracted light, such as ±1^{st}-order diffracted light. When an optical system is configured in such a way that a photodetector is placed in accordance with diffracted light of an order to be utilized, diffraction efficiency is determined so as to enable receipt of light in each of the regions at a similar distribution of light quantity, thereby enabling reduction of stray light. The optical attenuation device that guides diffracted light other than the 0^{th}-order transmitted light to the photodetector can be placed in an optical path shared between the forward path and the return path, and the return path is given an optical path differing from the forward path. Hence, the optical attenuation device also preferably includes the function of a beam splitter.

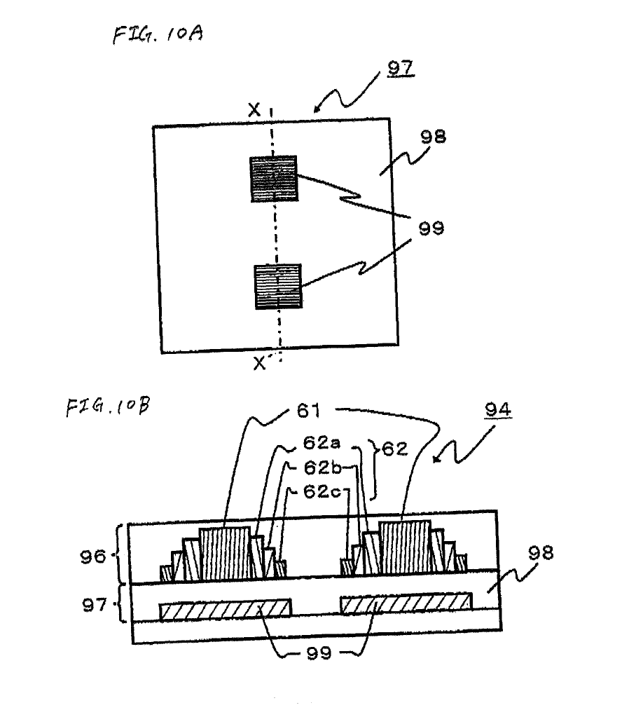

The optical attenuation device, such as that mentioned above, is placed at 16a and 18b, or as either of them, in the optical head device 10a, and the light guided to the photodetector 17 is depicted as a schematic plan view of FIG. 9. Outgoing light from the light source 11 turns into three beams, as mentioned previously, in the diffraction element 12. Light returned from the optical information recording plane 16a of the optical disk 16 is guided to the photodetector 17 by means of the beam splitter 13. In the photodetector 17, a main beam 84 and two sub-beams 85 and 86 are guided respectively to mutually-separated light receiving areas 81, 82, and 83. The light receiving areas can also be additionally divided as shown in FIG. 9.

Meanwhile, light reflected by an unillustrated layer, which is different from the information recording plane 16a, does not come into a focus on the layer and hence turns into stray light 87 having a greatly-increased diameter in the photodetector 17. When the optical attenuation device is not placed in the optical path, the stray light 87 also arrives at the light receiving areas 81, 82, and 83, where the stray light interferes, in an overlapping fashion, with the signal light from the information recording plane 16a. Accordingly, as a result of use of the optical attenuation device of the present: invention in the optical path, there are generated areas where stray light does not arrive at as indicated by reference numerals 88 and 89, so that interference with signal light can be diminished. FIG. 9 is a schematic view acquired when there is performed geometrical, optical simulation that does not take into account diffraction of intensity-modulated light, which would otherwise be caused by transmissivity modulation in the optical attenuation device.

In the present embodiment, an optical attenuation device is arranged in each of the sub-beam light receiving areas 82 and 83 of the photodetector shown in FIG. 9 in such a way that the second and third region of each optical attenuation device are corresponded. As mentioned previously, areas equivalent to the second and third regions are provided on an optical attenuation device even in the main beam light receiving area 81, whereby interference between the main beam and stray light can be more preferably diminished. The regions can also be similar to a shape encompassing a plurality of light receiving areas or the shape of a light receiving area.

As mentioned above, geometries of the second and third regions are preferably arranged at positions through which, of a luminous flux consisting of stray light that passes through the optical attenuation device 18a or 18b shown in FIG. 1 and that has returned from the other layer of the multilayer optical disk, a luminous flux arriving at the light receiving areas 82 and 83 or the light receiving areas 81, 82, and 83 shown in FIG. 9 passes. In the case of a multilayer optical disk having four or more information recording layers, another layer preferably means a layer adjoining a target layer. The reason for this is that luminous density of stray light from an adjoining layer particularly poses a problem of large crosstalk on the photodetector.

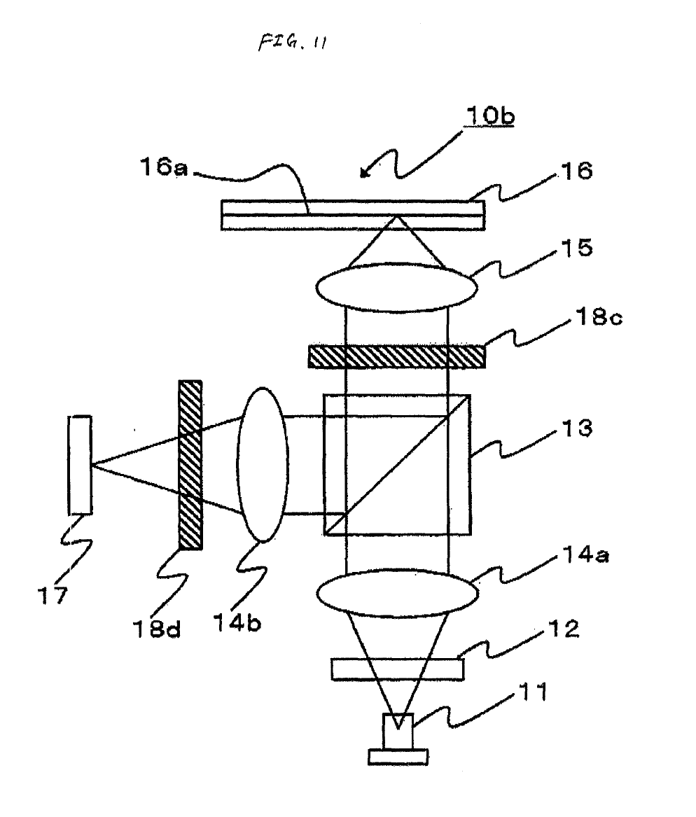

FIGS. 10A and 10B show a third embodiment embodied by an optical element that is a combination of a modulation element and a polarizer. A method for attenuating incident light is implemented by modulating a polarizing direction of incident light by use of a modulation element, to thus cut off a component of light in a specific polarized state. The modulation element may be an element that changes a polarized state of outgoing light with respect to a polarized state of incident light by means of a polarizing plate or an element like a polarization rotator that causes incident light to exit after having rotated a polarized state of the incident light. An embodiment using a wavelength plate as a modulation element will now be described. FIG. 10A is a schematic plan view of a polarizer 97 that is made up of a transmission region 98 and a polarization block region 99. The polarization block region 99 prevents rectilinear passage of a specific component of incident light by reflection, diffraction, and the like. For instance, provided that linearly-polarized light parallel to the direction of line X-X′ within the plane of the polarizer 97 shown in FIG. 10A is defined as polarized light “s” and that linearly-polarized light perpendicular to the direction of line X-X′ within the plane of the polarizer 97 is defined as polarized light “p,” the polarization block region 99 has the function of blocking passage of only the component of the polarized light “p.” As a matter of course, the polarization block region 99 may also be provided for blocking the polarized light “s.”

The region making up the wavelength plate 96 assumes the same shape as that shown in FIG. 5A, and like reference numerals are given to like elements, whereby their repeated explanations are omitted. FIG. 103 shows a cross sectional profile of the optical element 94 achieved when the optical element is cut along the direction of line X-X′. When the optical element 94 is made by superimposing the wavelength plate 96 on the polarizer 97, it is preferable to place at least the second regions 61 and the third regions 62 of the wavelength plate 96 within the respective polarization block regions 99 of the polarizer 97 when viewed in the direction of the optical axis in such way that outgoing stray light from the second and third regions enter the corresponding polarization block regions. The polarization block regions 99 assume a square shape. However, the shape of an outer edge of the polarization block region is not limited, so long as the polarization block region is arranged in such a way that outgoing light from the second and third regions enter the corresponding polarization block region.

The second regions 61 and the third regions 62 are made of a material that exhibits optical birefringence, and a retardation value of each of the regions is adjusted by controlling the thickness of the region. The polarized state of light entered while remaining in an uniform polarized state can be changed for each of the regions by way of which light exits from the wavelength plate, by means of imparting the retardation values to the respective regions as mentioned above. For instance, when linearly-polarized light that is to change to 100% of polarized light “s” enters the optical element 94, light in the first regions of the wavelength plate exits as the polarized light “s” without modification of the polarized state. In contrast, the second regions 51 are designed so as to be imparted with a retardation value (2n+1)λ/2 with regard to the wavelength λ of incident light (an integer n≧0). Specifically, incident light entered while including 100% of polarized light “s” exits in a state of including nearly 100% of a polarized light “p” as a component. The third region 62 is further divided into three divided regions 62a, 62b, and 62c and designed in such a way that a proportion of light that exits in the form of polarized light “s” becomes greater stepwise in sequence of 62a, 62b, and 62c.

Outgoing light from the respective regions of the wavelength plate enters the polarizer 97, and the component of the polarized light “p” is blocked by the polarization block regions 99, whereupon the component of the polarized light “s” exits. The outgoing light (polarized light “s”) from the optical element 94 has different light intensity with respect to each region. Hence, influence of crosstalk between signal light and stray light in the optical head device can be diminished. In this case, the polarization block regions 99 are arranged in correspondence with the respective sub-beams but can also be arranged in the region including the main beam. When light including 100% of polarized light “s” enters as in the above embodiment, the polarization block region can also be provided over the entire effective region where light enters. Outgoing light from the first region exits from the optical element 94 without being greatly attenuated by the polarizer; hence, a similar effect is yielded. The polarizer 97 may also permit passage of the polarized light “s” and diffract the polarized light “p” in a direction differing from a rectilinear direction by use of a diffraction grating and can be implemented by using liquid crystal as a birefringent material. When liquid crystal is sandwiched between transparent electrodes so that a voltage can be applied to the liquid crystal, the liquid crystal can be switched so as to act; for example, as a polarizer during application of no voltage and permit passage of light during application of a voltage. In this case, during recording or reproduction of data in or from a monolayer optical disk that is less vulnerable to crosstalk, a voltage is applied to the liquid crystal, thereby enhancing an optical efficiency. Moreover, the optical attenuation function can be similarly switched by applying a voltage to a wavelength plate as well as to the polarizer.

The optical element 94 is not limited to the configuration in which the wavelength plate 96 and the polarizer 97 are integrally overlaid, one on top of the other, but they may also be arranged separately from each other. For instance, when the wavelength plate 96 is placed immediately behind the collimator lens 14b in an optical path of return path and when the polarizer 97 is placed immediately in front of the photodetector in the same, the main beam of signal light passes through the transmission region 98 of the polarizer 97 in a focused state. Hence, the component of the polarized light “p” as well as the component of the polarized light “s” arrive at the photodetector without undergoing attenuation, so that the optical efficiency of the main beam is increased.

Although descriptions have been provided for the action achieved when the polarized state of light entering the optical element 94 is linearly polarized light, the polarized state of incident light may also be the state of circularly polarized light or the state of elliptically polarized light. For example, polarized light can also be caused to enter a polarizer in a form in which the phase plate is imparted with the function of converging circularly polarized light into linearly polarized light. The polarizer can also exhibit an effect of blocking circularly polarized light in a specific direction by use of cholesteric liquid crystal as well as exhibiting an action of blocking a specific component of linearly polarized light. Thus, the optical element including a wavelength plate that changes the polarized state of incident light is positioned at the location of the optical attenuation device 18b instead in an optical path of return path of the optical head device shown in FIG. 1 rather than in the optical path common between the forward path and the return path in the optical head device.

FIG. 11 is a view showing a conceptual configuration of an optical head device 10b having a hologram element as the optical element of the present invention. In the optical head device 10b, elements having the same features as those of the optical head device 10a shown in FIG. 1 are assigned the same reference numerals, and their repeated explanations are omitted. The hologram element of the present invention is placed in an optical path common to a forward path and a return path or in an optical path of return path differing from a forward path. In FIG. 11, a hologram element 18d is placed in only the return path, and a hologram element 18c corresponds to an example placed in an optical path common to a forward path and a return path. The hologram element is not limited to the configuration in which the element is placed in two optical paths, but the hologram element can also be placed in only either of the optical paths.

The photodetector 17 detects a read signal pertaining to information recoded in the information recording plane 16a of the optical disk 16, a focus error signal, and a tracking error signal. The optical head device 10b has an unillustrated focus servo that controls a lens in the direction of the optical axis in accordance with the focus error signal and an unillustrated tracking servo that controls the lens in a direction substantially perpendicular to the optical axis in accordance with the tracking error signal.

The photodetector 17 is equipped, as a set, three light receiving areas; one for receiving a main beam and the other areas for receiving two sub-beams. Under the 3-beam method, each of the light receiving areas is usually further divided into a plurality of regions and assumes a push-pull configuration for detecting a tracking signal. There can also be used a photodetector having the function of separating an area, at which signal light and stray light arrive with a large overlap between light receiving areas, as a dead zone from the light detection regions, thereby reducing an interference regions in the light receiving areas.

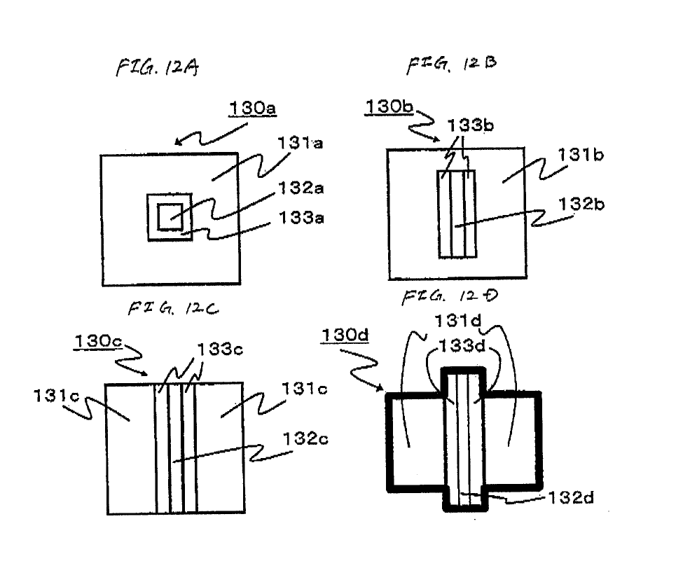

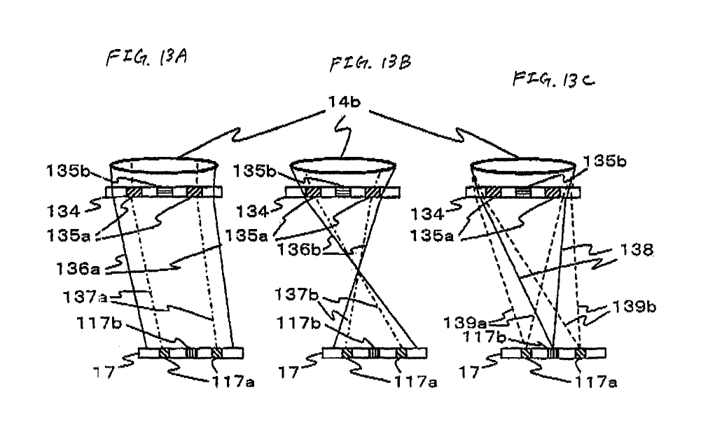

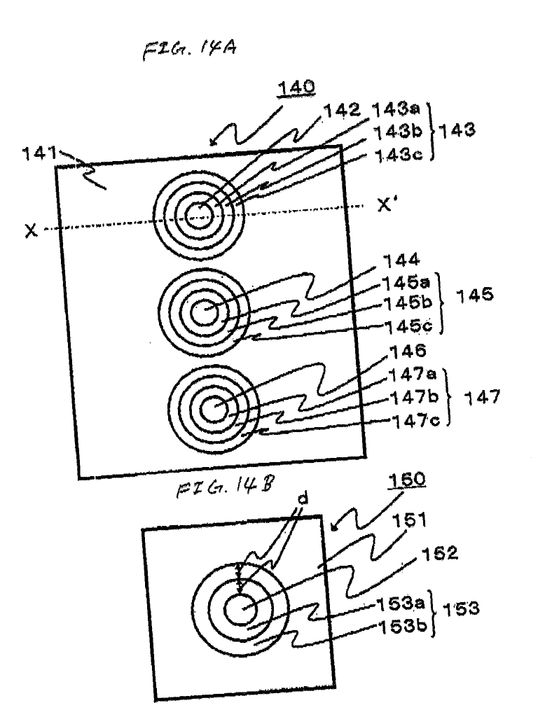

FIGS. 12A, 12B, 12C and 12D show respective schematic plan views of hologram elements 130a, 130b, 130c, and 130d of a fourth embodiment. The hologram element 130a is divided into a first region 131a including an enclosure of the hologram element, a third region 133a located inside an outer edge of the first region 131a, and a second region 132a located inside an outer edge of the third region. Here, the word “outer edge” herein means the outermost interface making up the region. The outer edge of the second region does not always locate inside the outer edge of the third region, and portions of these outer edges may contact as shown in FIGS. 12B and 12C. Moreover, even when the third region is separated into two sub-regions as a result of an outer edge of a second region 132b contacting an outer edge of a third region 133b at two discontinuous locations as shown in; for instance, FIG. 12B, the two sub-regions are assumed to be collectively taken as a third region 133b, and the outer edge of the third region is assumed to be unambiguously determined. In FIG. 12C, even when a second region 132c and a third region 133c contact an outer edge of a first region 131c at two locations, the outer edge of the first region is likewise assumed to be unambiguously determined. Even in an example, such as that shown in FIG. 120, a first region 131d is assumed to correspond to a combination of two sub-regions, and an outer edge of the first region is also assumed to be unambiguously determined as a thick line that includes a partial outer edge of a second region 132d and a partial outer edge of a third region 133d.

The first region has a diffraction grating structure, and signal light from the optical disk and enters the first region is diffracted in a direction differing from a rectilinear direction, to thus be guided to the photodetector. The essential requirement for the second region is to have a structure that causes the signal light entered the second region to exit to a direction differing from the direction of the photodetector. Therefore, for instance, an isotropic material having a flat, transparent surface is used for the second region, to thus permit rectilinear passage of incident signal light. In this case, the structure of the hologram element becomes simple, and hence productivity is enhanced. Alternatively, the hologram element can also have a diffraction grating structure that diffracts incident signal light in a direction differing from the direction of the photodetector. In this case, since the hologram element can be matched with the structure of the optical head device, the degree of freedom is increased. Further, incident light, is diffracted in a direction greatly differing from the direction of the photodetector, whereby an effect for lessening noise in the photodetector can be expected.

Provided that ratios of quantities of signal light diffracted by the regions to enter the photodetector to quantities of signal light entering the first, second, and third regions are taken respectively as transmissivity T1, T2, and T3, a relation is set to T1>T3>T2. Each of the transmissivity T1 of the first region and the transmissivity T2 of the second region is made substantially uniform respectively. Transmissivity of each of the regions can be adjusted by utilization of characteristics, such as absorption, reflection, and diffraction of light, or combinations thereof. When settings are made in such a way that T2 assumes a value of zero, stray light does not preferably enter the photodetector. Moreover, the optical element is made up of the hologram element, and the signal-to-noise ratio is increased for the same reason as that of the first embodiment. Hence, a preferred design is to cause the first region to account for an area of 70% or more of the effective region. When the distribution of transmissivity is present in the third region as will be described later, average transmissivity achieved in the third region is taken as T3.

Moreover, the main beam and the sub-beams rectilinearly passed through the second region of the hologram element or diffracted in a direction differing from the direction of the photodetector may also be received by another differently-arranged photodetector. In this case, when compared with a case where light is received by one photodetector, an optical efficiency of signal light can be increased.

When transmissivity achieved in the plane of the hologram element smoothly changes like a Gaussian distribution in a direction from the first region to the third region and further to the second region, diffraction of intensity-modulated light is inhibited, and the signal-to-noise ratio caused by signal light and stray light can be preferably increased. In the fourth embodiment, the third region is configured so as to have substantially-uniform transmissivity. However, a more preferred configuration is to exhibit consecutive transmissivity change like a Gaussian distribution. Even when the transmissivity of the third region is substantially uniform, diffraction of intensity-modulated light can be inhibited, so long as the transmissivity is analogous to the Gaussian distribution. As in the first embodiment, the same goes even for the hologram element, and a Gaussian approximate distribution shown in FIG. 3A can be adopted. Therefore, in this configuration, provided that T2/T1≦0.1, it is preferable that transmissivity can be caused to approximate to the Gaussian distribution when transmissivity is designed so as to fall within a range of 0.3≦T3/T1≦0.7. Therefore, transmissivity falling within a range of 0.4≦T3/T1≦0.6 is more preferable.

The value of transmissivity is designed; for instance, such that T1 assumes a value of 80% or more, so that signal light can be efficiently, preferably guided to the photodetector. Hence, the value of transmissivity is preferably 90% or more. The stray light arriving at the photodetector can preferably be reduced by causing the transmissivity T2 of the second region to approximate to zero. When a distance between the outer edge of the second region and the outer edge of the third region, which will become the width of the third region, is short, a transmissivity change becomes abrupt, so that the stray light removal effect becomes smaller. The width and area of the third region are determined in agreement with the shape of the lens and the light receiving area and in such a way that the ratio of signal light entering the first region becomes greater.

As mentioned above, the third region having intermediate-level transmissivity T3 is interposed between the second region having low T2, which is preferably T2=0, and the first region having high T1. Since the transmissivity change arising in the interface between the regions can be diminished, diffraction of intensity-modulated incident light, which would otherwise be caused by the distribution of transmissivity of the hologram element, can be inhibited. According to the above, in particular, wraparound of stray light in the photodetector that receives sub-beams can thereby be reduced, so that occurrence of interference of signal light with stray light can preferably be inhibited.

A layout of the hologram element is now described. FIG. 13 shows a schematic cross-sectional view of the state of light achieved when a hologram element 134 is interposed in an optical path between the collimator lens 14b and the photodetector 17. FIGS. 13A and 13B show states of beams of stray light that do not come into a focus on the respective photodetector, and FIG. 13C shows a focused state of signal light. The polarization element 134 has three separated second regions 135a and 135b. Unillustrated third regions are assumed to be provided around the respective second regions. Reference numeral 135a designates second regions for sub-beams as will be described later, and reference numeral 135b designates a second region for a main beam. The photodetector 17 has light receiving areas 117a for sub-beams and a light receiving area 117b for a main beam. The schematic view of FIGS. 13A to 13C show only the light that exits the hologram element after having undergone diffraction, to thus arrive at the photodetector 17, in order to show a manner of attenuation of stray light. However, the stray light may be light that exits at a different angle of diffraction by means of the function of the hologram element, or rectilinearly-traveling light.

Stray light that does not come into a focus on the photodetector 17 is first described. In FIG. 13A, stray light 136a that undergoes diffraction in the hologram element 134, to thus come into a focus behind the photodetector arrives at the photodetector 17 without being much converged in the optical path. At this time, a beam 137a of stray light passing through the center of each of the second regions 135a is indicated by a dashed line. It is better to guide the beam 137a to the center of each of the light receiving areas 117a. The stray light 136b having a focal point ahead of the photodetector in FIG. 13B arrives at the photodetector 117 while the width of light remains spread. At this time, a beam 136b of stray light passing through the center of each of the second regions 135a is designated by a dashed line, and it is likewise better to guide the beam 136b to the center of each of the light receiving areas 117a. When the second region 135b is provided for use with a main beam, it is better to arrange the second region 135b so as to include an optical axis of the main beam and converge light at the main beam light receiving area 117b. It is much better to align the optical axis with the center of the second area 135b and the center of the light receiving area 117b.

As long as the stray light passing through the second region of the hologram element is guided to the sub-beam light receiving area 117a as mentioned above, the stray light arrives at the light receiving area while being reduced. Additionally, the presence of the third region makes it possible to effectively diminish the stray light. Respective beams of stray light are generated by reflection of the main beam and the sub-beams from the optical recording medium. However, the beams of the stray light are not converged on the photodetector. Moreover, the stray light of the sub-beams is less intensive than the stray light of the main beam in terms of the quantity of light. Therefore, the stray light can be roughly considered to be reflected light originating from the main beam. Moreover, when the outer edge of the light receiving areas and the outer edge of the second region have an analogous shape, an optical efficiency is preferably increased. FIG. 13C shows the focused state of signal light. Sub-beams 139a and 139b are guided in a focused manner to the respective sub-beam light receiving areas 117a, and the main beam 138 is guided in a focused manner to the main beam light receiving area 117b. Although descriptions are provided by reference to the hologram element 140, the hologram element 130a may also be used instead. Even in this case, it is better to arrange the second region so as to include the beams of the stray light arriving at the respective light receiving areas and the optical axis.

FIG. 14A shows, as a fifth embodiment, an example schematic plan view of a hologram element in which the third region is further divided into a plurality of segments. A hologram element 140 shown in FIG. 14A is divided into a highly-transmissive first region 141, three second regions 142, 144, 146, and three third regions 143, 145, 147. The third region 143 is further made up of three divided regions 143a, 143b, and 143c; the third region 145 is further made up of three divided regions 145a, 145b, and 145c; and the third region 147 is further made up of three divided regions 147a, 147b, and 147c. The number of segments into which each of the third regions is to be divided is not limited to three and can also be two or four or greater. Further, transmissivity may also exhibit a continually-changing distribution pattern from the first region to the second regions.

In the present mode, an unillustrated main beam light receiving area, an optical axis of a main beam, and the second region 144 are aligned, with each other, and the hologram element 140 is arranged in such a way that beams of stray light arrived at respective centers of unillustrated sub-beam light receiving areas pass through the second regions 142 and 146, respectively. The present mode is not limited to a configuration in which the second and third regions are concentrically distributed, but the regions may assume a shape including a polygon and an arbitrary curve. Further, outer edges of respective regions may contact an outer edge of another region. The third embodiment can also adopt the configuration of a hologram element that is caused to act on only two sub-beams vulnerable to crosstalk induced by stray light. The optical axis of the main beam and the beams of stray light preferably fall within the second regions; namely, at points of center of the second regions. For instance, when the second regions are circular, the optical axis and the beams of stray light are located at the respective points of center of the circles. It is more preferably to connect the centers of the respective light receiving areas to the center of the respective second regions.

In FIG. 14A, the transmissivity of the first region 191 is taken as T1, and transmissivity of the second regions 142, 149 and 196 is taken as T2. In the third regions, transmissivity of the regions 143a, 145a, and 147a is taken as Tr1; transmissivity of the regions 143b, 145b, and 147b is taken as Tr2; and transmissivity of the regions 143c, 145c, and 147c is taken as Tr3. When a relationship among the respective transmissivity levels is set as T1>Tr3>Tr2>Tr1>T2, transmissivity becomes stepwise greater from the centers of the second regions toward the outer edges, whereby diffraction of intensity-modulated stray light, which would otherwise arise in the interfaces among the regions, can preferably be inhibited. The regions into which the three third regions are further divided are imparted with the same transmissivity. However, the regions may also assume different transmissivity levels, so long as the inequality is fulfilled by the respective third regions.

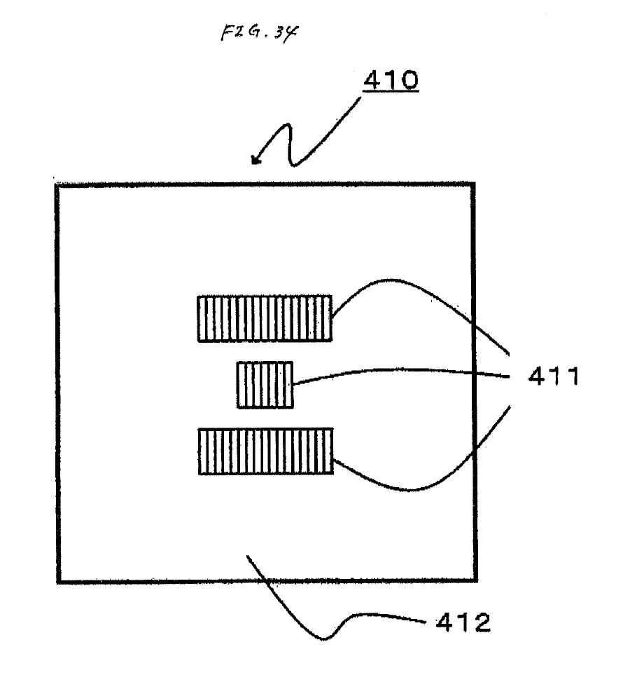

There will now be described a method for setting the value of a difference of the transmissivity levels between regions having different transmissivity levels achieved when the third regions are divided into a plurality of segments. By way of example, a hologram element 150 is divided as shown in FIG. 14B, wherein a third region 153 is divided into regions 153a and 153b that have the same width “d.” Even in connection with the hologram element, transmissivity changes can be considered in the same manner as in the second embodiment, A Gaussian approximation distribution shown in FIG. 33 can be adopted. Therefore, when T2/T1≦0.1 is achieved by the configuration, the maximum value of a normalized transmissivity difference between regions with different transmissivity levels is (Tr2−Tr1)/T1=0.6. Therefore, it is preferable to set to a value ranging from over 0 to 0.7 the normalized transmissivity difference between the regions that are adjacent to each other with an interface therebetween and that differ from each other in terms of transmissivity. Setting the transmissivity difference to a value ranging from over 0 to 0.6 is more preferable. When the third region is divided into three or more regions in such a way that transmissivity changes stepwise, the normalized transmissivity difference can be made smaller than a value of 0.6 with an increase in the number of segments to which the regions are divided, whereby the difference more approximates to a change in Gaussian distribution.

When the value of transmissivity is designed in such a way that T1 assumes; for instance, a value of 80% or more, signal light can preferably be guided efficiently to a photodetector. A value of 90% or more is more preferable. Stray light arriving at the photodetector can preferably be further reduced by making the transmissivity T2 of the second regions approximate to zero.

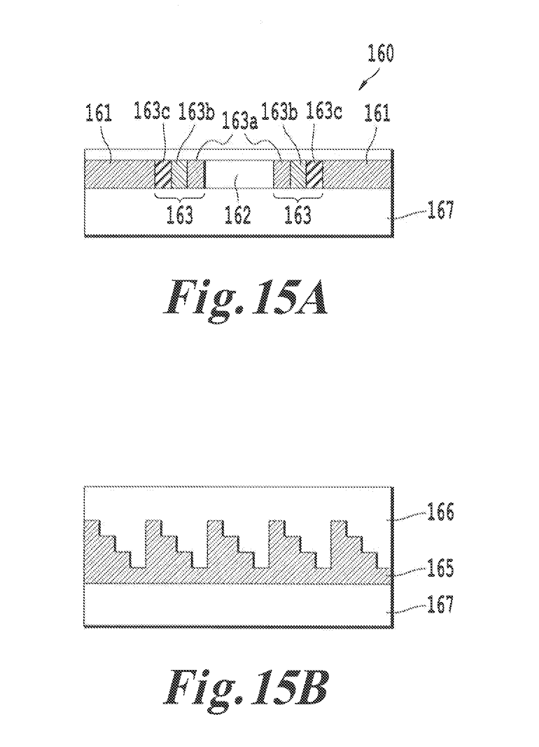

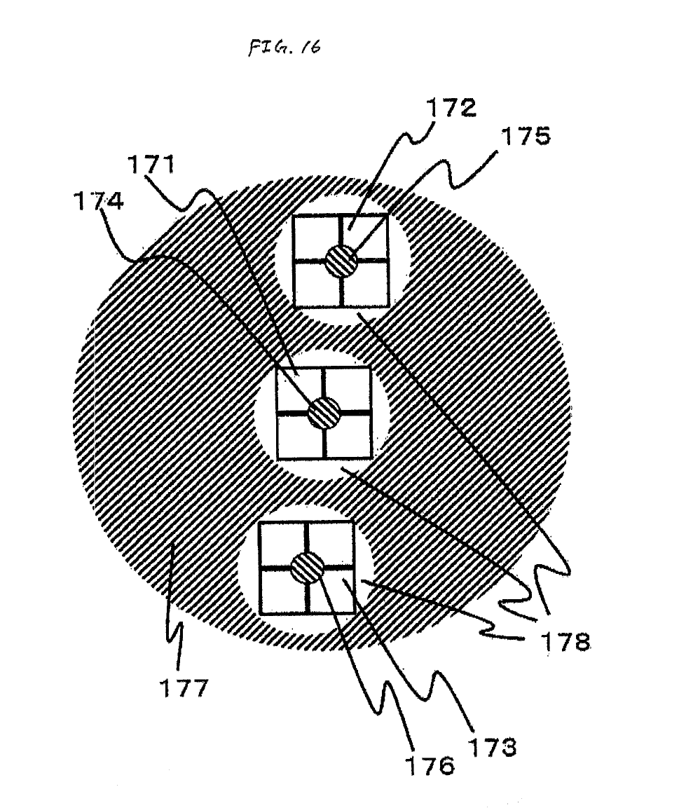

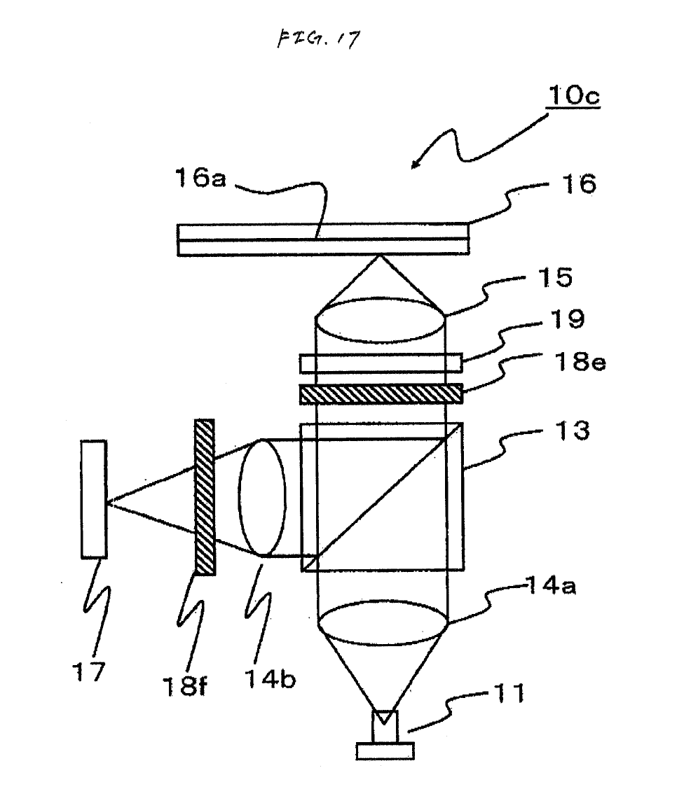

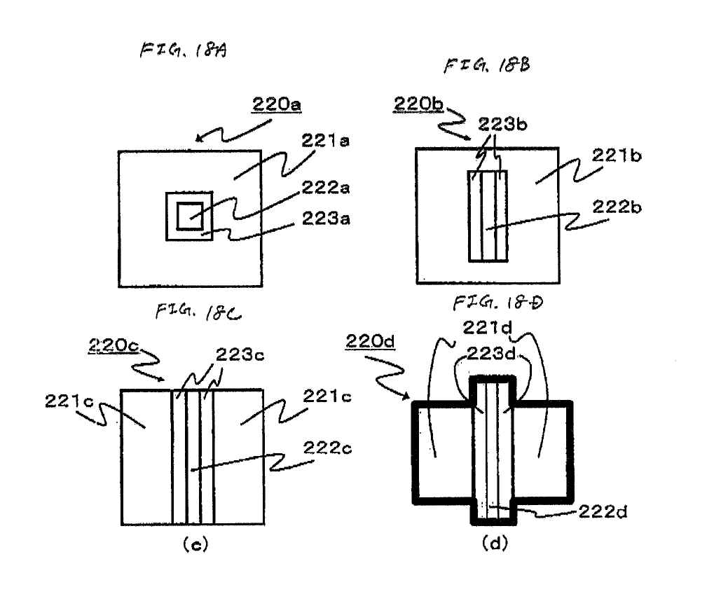

A specific configuration for activating the hologram element will now be described. FIG. 15A shows a schematic cross-sectional view of a hologram element 160 that is to be fabricated in a region exhibiting diffraction. FIG. 15; is a schematic cross-sectional view cut along a straight line passing through the point of center of a second region as indicated by X-X′ shown in FIG. 14A. Each of the regions assumes a diffraction grating structure having a periodical convexoconcave cross sectional profile. In this case, a first region 161, a second region 162, and three divided regions 163a, 163b, and 163c making up a third region 163 are built from diffraction gratings having a structure in which diffraction is effected stepwise by means of diffracting action and in which transmissivity of light guided to a photodetector as first-order diffracted light changes from one region to another. The first order is used for the order of diffracted light guided to the photodetector. However, the order of the diffracted light is not limited to the first order. Higher-order diffracted light, such as the second-order diffracted light and the third-order diffracted light, any negative order diffracted light, such as the −1^{st}-order diffracted light, or a combination of diffracted light beams, can also be used. The second region 162 has the lowest transmissivity T2 as mentioned above, and transmissivity is designed so as to become higher, within the plane of the hologram element, from the second region toward the first region, i.e., toward the outside. In particular, preferred transmissivity T2 of the second region is zero.

Transmissivity, which acts as the 1^{st}-order diffraction efficiency of light diffracted by the diffraction grating structures of the respective regions, may also be realized by changing and adjusting the depth of indentations of a diffraction grating structure made in the surface of each of the regions, the refractive index of a convexoconcave grating material, and a ratio (a Duty ratio) of width of indentations and protrusions of the gratings. As mentioned above, the second region are preferably provided with a structure for inhibiting outgoing light from the second region from arriving at the photodetector (T2=0), and therefore transmissivity can be adjusted by a combination of the second region with a structure exhibiting light reflecting, absorbing, and diffracting actions. The structure can also adapt to the third regions that permit entry of light to the photodetector by reducing transmissivity as well as to the second region; and adjusts transmissivity of light entering the photodetector by adjusting a shape of the structure, thereby enabling performance of gradation in a manner that transmissivity stepwise changes within a plane. A multilayer film in which a high refractive index material and a low refractive index material are periodically stacked, a cholesteric liquid-crystal material, and the like, are used as the structure exhibiting the light reflecting action. A diffraction grating having periodic protrusions and indentations can be utilized in the second region as an element exhibiting a diffracting action. However, so long as an outgoing direction of light diffracted by the diffraction grating is greatly different from the direction of the photodetector, stray light can be reduced much. The cross sectional profile of the diffraction grating structure is not limited to a rectangular shape. As long as the cross sectional profile assumes the shape of a saw blade (a blaze shape), transmissivity (the 1^{st}-order diffraction efficiency) can preferably be enhanced. When the diffraction grating assumes a blaze shape, transmissivity can also be adjusted by changing the number of steps of a stair-like structure making up the blaze shape.

The second region 162 has a diffraction grating structure as mentioned above and may also exhibit an action for diffracting light in a direction differing from the direction of the photodetector. However, in FIG. 15A, the second region can also be integrated with; for instance, a transparent substrate 167, to thus embody a structure that allows rectilinear passage of incident light without diffraction, to thus prevent incidence of light on the photodetector. In this case, there is no necessity for a diffraction grating structure, and productivity is preferably enhanced.

FIG. 15B is a schematic cross-sectional view showing an example diffraction grating structure. For the sake of convenience, an interface of the diffraction grating is depicted by a straight line in FIG. 15A. In an actual cross section, the first region 161 and the third region 163 that exhibit at least a diffracting action become a combination of the first optical material 165 making up a hologram element and the second optical material 166 differing in refractive index from the first optical material, as shown in FIG. 15B. This is not limited to the third embodiment but common to the regions with the diffraction grating structures described in connection with the first and second embodiments. Each of the first optical material 165 and the second optical material 166 may be an isotropic material, a birefringent material exhibiting refractive-index anisotropy, or a combination thereof. The minimum requirement for the first and second optical materials is to have a structure that exhibits a different refractive index with respect to light in a specific direction of polarization. In the example shown in FIG. 15B, the cross-sectional profile of the diffraction grating structure is realized as a stair-like pseudo blaze shape. However, the cross-sectional profile may also be a non-stair-like blaze shape or a binary, convexoconcave shape. So long as the cross-sectional profile assumes a blaze shape or a pseudo blaze shape, the diffraction efficiency of the light is increased, whereby an optical efficiency can preferably be increased. Further, among blaze shape, a pseudo blaze shape is preferably easy to make.

In a case where the hologram element is disposed at the position designated by reference numeral 18c in the optical head device 10b, a birefringent material is used for the first optical material 165, and projections and indentations in the surface of the diffraction grating are filled, in a planarized fashion, with the second optical material 166 made of an isotropic material whose refractive index is substantially equal to an ordinary refractive index (no) or an extraordinary refractive index (ne). As will be described later, in an optical path of forward path, the hologram element permits incident light to pass through without substantially undergoing diffraction. In an optical path of return path, the hologram element can preferably be caused to act as the above. Further, the hologram element of the configuration may naturally be disposed at the position designated by reference numeral 18d. An acrylic material, an entiol-based material, an epoxy-based material, and the like, can also be used for a filling material. A material to be used for filling is not limited to an isotropic material. The essential requirement is that, even when the first optical material 165 and the second optical material are birefringent materials exhibiting mutually-different refractive indices, the materials match each other in terms of “no” or “ne.” Further, when the hologram element is disposed only at the position 18d in an optical path of return path, the material making up the hologram element may also be a combination of two types of isotropic materials having different refractive indices.

The hologram element 140 having a diffraction grating structure, such as that mentioned above, in which the combination of the first optical material 165 and the second optical material 166 corresponds to a combination of a birefringent material and an isotropic material, is disposed at the position designated by reference numeral 18c in the optical head device 10b shown in FIG. 11. At this time, the outgoing light from the light source 11 is linearly polarized light, and the hologram element 18c (=the hologram element 140) is arranged so as to exhibit high rectilinear transmission efficiency in all of the regions in connection with the linearly polarized light in the forward path. In short, the hologram element is arranged in a direction where the linearly polarized light in the forward path matches either an ordinary refractive index (no) or an extraordinary refractive index (ne) of the birefringent material and the refractive index of the isotropic material and does not undergo a change in refractive index. When the quarter wavelength plate (not shown) that converts polarized light traveling toward the optical disk 16 along the forward path into circularly polarized light is interposed in an optical path between the hologram element 18c and the objective lens 15, the light reflected from the optical disk 16 along the return path again passes through the unillustrated quarter wavelength plate, to thus become linearly polarized light orthogonal to the linearly polarized light in the forward path. When the light converted into linearly polarized light in the return path as mentioned above enters the hologram element 18c, the light undergoes a change in refractive index at an interface between a birefringent material and an isotropic material making up the diffraction grating structure. Light in the return path undergoes diffraction while the quantity of light is changed by transmissivity the first-order diffraction efficiency) that is different with respect to each region in the hologram element 18c. In FIG. 11, the signal light reflected from the optical disk 15 is illustrated so as to enter the hologram element and rectilinearly travel. However, the drawing is a schematic view for the sake of convenience. In reality, the optical system is designed and arranged in alignment with a diffracting direction. Moreover, when the hologram element made up of a birefringent material and an isotropic material is disposed at; for instance, the position 18c, the traveling direction of the light in the return path reflected from the optical disk can be adjusted by subjecting the light to diffraction. Therefore, an optical head device can also be materialized without arrangement of the beam splitter 13.

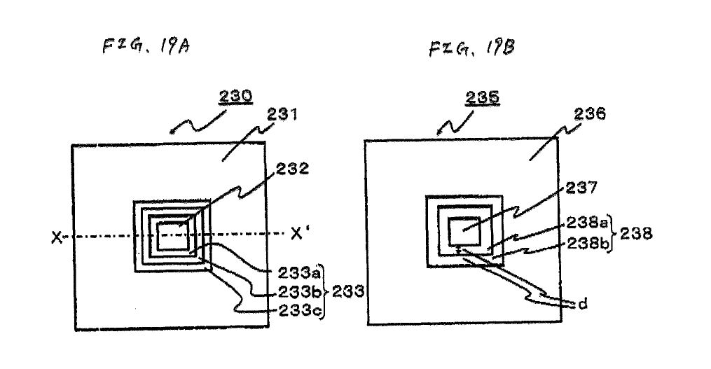

The hologram element, such as that mentioned above, is disposed at the positions 18c and 18d, or any one of them, in the optical head device 10b, and the light guided to the photodetector 17 is illustrated as the schematic plan view of FIG. 16. When the hologram element 18d is interposed between the beam splitter 13 and the photodetector 17 of the optical head device 10b, the outgoing light from the light source 11 is divided into three beams by the diffraction element 12 as mentioned previously. The signal light reflected from the optical information recording plane 16a of the optical disk 16 is reflected by the beam splitter 13 and guided to the photodetector 17 by the hologram element 16d. In the photodetector 17, one main beam 174 is guided to a light receiving area 171; and two sub-beams 175 and 176 are guided to respective light receiving areas 172 and 173. The light receiving areas are further divided into a plurality of regions as shown in FIG. 16.

Descriptions are now provided by use of; for instance, the hologram element 140 shown in FIG. 14A. Of the signal light, stray Light arriving at the centers of the unillustrated sub-beam light receiving areas are aligned to the respective second regions 142 and 146, and the optical axis of the main beam is aligned to the second region 144. In particular, it is desirable, in this case, that the beams and the optical axis are aligned to the center points of the respective regions. When the return light, which has entered, undergone diffraction, and then exited the hologram element 140 shown in FIG. 14A, is guided to the photodetector, light reflected from an unillustrated layer, which differs from the information recording plane 16a, does not come into a focus on that layer. Therefore, the diameter of the reflected light becomes broadened on the photodetector 17, whereupon stray light arrives at a region 177, such as that shown in FIG. 16. When the hologram element is not disposed in the optical path, stray light arrives at the light receiving areas 171, 172, and 173, as well, thereby interfering with the signal light from the information recording plane 16a in an overlapping fashion. Meanwhile, as a result of use of the hologram element of the present invention in the optical path, a region where stray light arrives while being diminished is created as indicated by reference numeral 178; hence, interference with signal light can be reduced. Since diffracted light is used as light guided to the photodetector as mentioned above, interference attributable to leakage of transmitted light (the 0^{th}-order diffracted light) from the hologram element, which has arisen in the related art, can also be reduced.

When the second region is provided in accordance with the size of the light receiving area in such a way that the stray light arriving at the light receiving area is reduced, the proportion of quantity of light entering the first region among the effective regions is increased, so that an optical efficiency is preferably increased. For instance, in order to design and arrange a hologram element in which 70% or more of the effective regions comes into the first region, it is required that each the second region should account for at least an area of 10% or less of each of the effective regions. Depending on the light receiving areas and characteristics of the optical system, an area ratio of the second region to the effective regions is preferably 1% or more, because the region 178 where stray light arrives while being reduced is greater than the light receiving areas 171, 172, and 173 and because a given area ratio or more must be ensued in consideration of the range of fluctuations of the optical axis.

In the hologram element of the present invention, the second region and the third regions are arranged in correspondence with each other so as to reduce the stray light entering the main beam light receiving area 171 and the two sub-beam light receiving areas 172 and 173 of the photodetector shown in FIG. 16. As mentioned above, since the main beam is greater than the sub-beams in terms of a quantity, the main beam is less vulnerable to stray light, so that the second region and the third region may also be provided in the hologram element solely for the two sub-beams. The regions can also assume a shape encompassing a plurality of light receiving areas or a shape analogous to the shape of the light receiving areas.

As mentioned above, the second region and the third region are preferably arranged in such a way that, of the stray light corresponding to the light passed through the hologram element 18c or 18d shown in FIG. 11 and returned from another layer of the multilayer optical disk, the light arriving at the light receiving areas 171, 172, and 173 shown in FIG. 16 is diminished. In the case of a multilayer optical disk having four information recording layers or more, another layer is preferably a layer adjoining a target layer. The reason for this is that luminous density of stray light from an adjoining layer particularly poses a problem of interference due to high crosstalk on the photodetector.

FIG. 17 is a view showing a conceptual configuration of the optical head device 10c having a hologram element serving as an optical element of the present invention. In the optical head device 10c, elements analogous to those of the optical head device 10a shown in FIG. 1 are assigned the same reference numerals, and their repeated explanations are omitted. The optical head device 10c permits an outgoing beam to pass in the form of a single beam toward the optical disk 16. A quarter wavelength plate 19 is disposed in an optical path between a hologram element 18e and the objective lens 15. The hologram element of the present invention is applied to a single-beam optical head device, and disposed at a position where a single optical path acts as a forward path and a return path or in a return optical path among the forward path and the return path that differ from each other. In FIG. 17, a hologram element 18f is an example hologram element placed in only a return path, and the hologram element 18e is an example hologram element placed in the optical path shared between the forward path and the return path. The hologram element is not limited to the configuration where the hologram element is placed in two optical paths, but may also be placed in only any one of the optical paths.

The photodetector 17 detects a read signal pertaining to information recorded in the information recording plane 16a, which is to be subjected to reproduction, of the optical disk 16, a focus error signal, and a tracking error signal. The optical head device 10c has an unillustrated focus servo that controls a lens in a direction of its optical axis in accordance with a focus error signal and an unillustrated tracking servo that controls the lens in a direction substantially perpendicular to the optical axis in accordance with the tracking error signal.

The photodetector 17 shown in FIG. 17 conceptually represents one or a plurality of photodetectors. As will be described later, the photodetector has at least a first photodetector that receives a luminous flux having the largest quantity among beams exited from the first region of the hologram element after having undergone diffraction. Only the first photodetector may be sufficient as a photodetector to be provided in the optical head device. The optical head device may also has two photodetectors; namely, the first photodetector and a second photodetector that receives a luminous flux having the greatest quantity among beam that exited in a direction differing from the direction of the first photodetector after having rectilinearly passed through or undergone diffraction in the second region of the hologram element. So long as the optical head device is configured so as to have a plurality of photodetectors as mentioned above, load imposed on one photodetector as a result of function of the photodetector through processing for detecting a reproduced signal at the time of reproduction of data from an optical disk and generating a plurality of error signals, is lessened; hence, complication of a control circuit can be avoided. Alternatively, a direction in which a luminous flux having the second largest quantity or a subsequent luminous flux, among outgoing beams from the first photodetector, exits may also be made coincide with the direction of the second photodetector. In addition, the regions of the hologram element are further divided, or the structure of the diffraction grating is adjusted, whereby the optical head device may also be further provided with an additional third photodetector in a direction different from the directions of the first and second photodetectors.

FIGS. 18A, 18B, 18C and 18D show schematic plan views of hologram elements 220a, 220b, 220c, and 220d of a sixth embodiment. The hologram element 220a is divided into a first region 221a including an outer frame of the hologram element; a third region 223a located inside an outer edge of the first region 221a, and a second region 222a located inside an outer edge of the third region. Here, the word “outer edge” herein means the outermost interface making up the region. The outer edge of the second region does not always locate inside the outer edge of the third region, and portions of these outer edges may contact as shown in FIGS. 18B and 18C. Moreover, for instance, even when an outer edge of the second region 222b contacts an outer edge of the third region 223b at two discontinuous locations as shown in FIG. 18B, whereby the third region is separated into two segments, the two segments are collectively taken as the third region 223b, and the outer edge of the third region is assumed to be unambiguously determined. Even when a second region 222c and a third region 223c contact an outer edge of a first region 221c at two points in FIG. 18C, the outer edge of the first region is assumed to be likewise determined unambiguously. Even in an example, such as that shown in FIG. 18D, a first region 221d is a combination of two segments. The outer edge of the first region is assumed to be unambiguously determined as a thick line including a portion of an outer edge of a second region 222d and a portion of an outer edge of a third region 223d.

In the present embodiment, the second region is set in alignment with the light diffracted by the single beam method, and the second region is arranged in the hologram element so as to include an optical axis of signal light and an optical axis of stray light. For instance, it is better to align the point of center of the second region 222a with the optical axis in the hologram element 220a. In the present embodiment, the second region and the third region are distributed in such a way that analogous squares are aligned with their center of gravity. However, the regions are not limited to this configuration. The regions may also assume a concentric pattern or a pattern including a polygon or an arbitrary curve. Outer edges of respective regions may contact an outer edge of another region.

Ratio of quantities of signal light entering the first photodetector after having undergone diffraction in the first, second, and third regions to quantities of signal light entering the first, second, and third regions are taken as transmissivity and represented as T1, T2, and T3, and a relationship among the transmissivity levels is set to T1>T3>T2. The transmissivity T1 of the first region and the transmissivity T2 of the second region are made substantially uniform. The transmissivity T3 of the third region is made substantially uniform. Transmissivity of each of the regions can be adjusted by utilization of characteristics of light, such as absorption, reflection, and diffraction, or combinations thereof. So long as settings are made so as to achieve stray light entering the second region preferably fails to arrive at the first photodetector. As to the configuration of the hologram element, the signal-to-noise ratio is increased by increasing an optical efficiency for the same reason as that of the first embodiment. Hence, it is preferable to design the hologram element in such a way that the first area accounts for 70% or more of the effective regions. Consequently, it is required that each of the second region should account for an area of 30% or less of the effective regions. Depending on the light receiving areas and characteristics of the optical system, a value of 1% or more is sufficient for an area ratio of the second region to the effective regions, because the region where stray light arrives while being reduced is greater than the light receiving areas of the first photodetector and because a given area ratio or more must be ensued in consideration of the range of fluctuations of the optical axis.

When transmissivity smoothly changes within a plane of the hologram element from the first region to the third region and further to the second region like a Gaussian distribution, diffraction of intensity-modulated light is inhibited, so that a signal-to-noise ratio of signal light to stray light can preferably be increased. In the sixth embodiment, the third region is configured so as to assume substantially-uniform transmissivity. However, it is more preferable to configure the third region so as to assume consecutive changes in transmissivity as in the case with a Gaussian distribution. Even when the transmissivity of the third region is substantially uniform, diffraction of intensity-modulated light can be inhibited, so long as the transmissivity is made analogous to a Gaussian distribution. The hologram element can also be considered in the same manner as in the first embodiment, and the Gaussian approximation distribution shown in FIG. 3A can be adopted. In this configuration, if transmissivity is designed so as to fall within a range of 0.3≦T3/T1≦0.7 when T2/T1≦0.1, transmissivity can be caused to approximate to the Gaussian distribution. Hence, it is more preferable that transmissivity will fall within a range of 0.4≦T3/T1≦0.6.

For instance, signal light can be efficiently guided to the photodetector by designing transmissivity in such a way that T1 comes to 90% or more; hence, transmissivity is preferably be set to 90% or more. Stray light arriving at the first photodetector can further be reduced by causing transmissivity T2 of the second region to approximate to 0. When a distance between the outer edge of the second region and the outer edge of the third region, which will become the width of the third region, is short, a transmissivity change becomes abrupt, so that the stray light removal effect becomes smaller. The width and area of the third region are determined in agreement with the shape of the lens and the light receiving area and in such a way that the ratio of signal light entering the first region becomes greater.

As mentioned above, the third area having intermediate-level transmissivity T3 is interposed between the second region having low T2, which is preferably T2=0, and the first region having high transmissivity T1. Since the transmissivity change arising in the interface between the regions can be diminished, diffraction of intensity-modulated incident light, which would otherwise be caused by the distribution of transmissivity of the hologram element, can be inhibited. In particular, wraparound of stray light in the first photodetector can thereby be reduced, so that occurrence of interference of signal light with stray light can preferably be inhibited.

The hologram element, such as that mentioned above, may also be placed at 18e and 18f, or as either of them, in the optical head device 10c shown in FIG. 17. By way of example, a manner of light arriving at the photodetector 17 when the hologram element 220a shown in FIG. 18A is placed at the position 18f of the optical head device 10c is shown as a schematic plan view of FIG. 21. FIG. 21 shows the manner of signal light and stray light arriving at two photodetectors by passing through the hologram element; particularly, a light receiving area 251 of the first photodetector and a light receiving area 252 of the second photodetector. As mentioned above, the photodetector can also be solely the first photodetector, or a mode in which two photodetectors; namely, a first photodetector and a second photodetector, detect signal light, can also be feasible.

As an example, an optical system is designed in such a manner that the hologram element 220a is placed at the position 18f and that signal light exited from the first region 221a and the third region 223a after having entered and undergone diffraction in these first and third regions is converged on an area 253 in the light receiving area 251 of the first photodetector. Meanwhile, when stray light enters the hologram element 220a, outgoing light from the first region 221a and the third region 223a is diffracted toward the first photodetector as is the signal light. However, the light does not come into a focus at the position of the first photodetector, and therefore stray light arrives at a region as indicated by an area 255. Since the transmissivity T2, which is related to the light diffracted and exited toward the first photodetector, is low, the stray light entering the second region of the hologram element arrives at the light receiving area 251 of the first photodetector while being reduced in quantity or does not substantially arrive at the light receiving area 251. In particular, the transmissivity T3 of the third region 223a falls between the transmissivity T1 of the first region 221a and the transmissivity T2 of the second region 222a and can be set in such a way as to reduce the stray light arriving at the light receiving area 251 by inhibiting diffraction of intensity-modulated light. Therefore, the signal-to-noise ratio of light arriving at the light receiving area can be increased. Further, the light receiving area 251 of the first photodetector is further divided into four or more regions so as to be able to process optical information, such as a reproduced signal, a focus error signal, and a tracking error signal.

When signal light is received by solely the first photodetector, the essential requirement is that light entering the second region should exit in at least a direction differing from the direction of the first photodetector. In this case, neither the signal light nor the stray light entering the second region arrive at the light receiving area 251 of the first photodetector. In order to utilize the signal light entering the second region, the light receiving area 252 of the second photodetector is arranged in a direction in which the light entering the second region is caused to pass or in a direction which is different from the direction of the first photodetector and in which the light is to be diffracted. For instance, when substantially 100% of the light entering the second region passes through the region, the light receiving area 252 of the second photodetector is placed in a direction in which light rectilinearly travels. By way of another example, so long as the optical head device is configured in such a way that the light entering the second region exits in a plurality of directions as does the first-order diffracted light or rectilinearly-passed light, the second photodetector 252 is placed in a direction in which the largest quantity of light exits, whereby an optical efficiency is preferably increased.

When the light receiving area 252 of the second photodetector is placed in a direction of light exiting the second region, the signal light exiting the second region is converged on the region 254, to thus arrive at the light receiving area 252. However, the stray light exiting the second region does not come into a focus at the light receiving area 252 of the second photodetector and hence arrives at a region 256. Stray light cannot be caused to arrive at the inside of the light receiving area 252 of the second photodetector while being reduced in quantity as in the light receiving area 251 of the first photodetector. However, an optical signal, of received light information, that is less vulnerable to crosstalk can be processed.

For instance, a reproduced (RF) signal exhibits optical diffraction according to presence or absence of pits in an information recording plane of an optical disk. The signal enables performance of detection by reading ON/OFF of an optical signal arrived at the photodetector upon reflection from an optical disk. A focus error signal is generated by means of detecting the shape of light arriving at a light receiving area by means of an astigmatism by arranging an unillustrated cylindrical lens interposed between a hologram element and a photodetector, and computation of the quantity of light arriving at a plurality of segments making up the light receiving area A change in a computation result is detected, to thus achieve a constant value, whereby the light is modified to a given shape, to thus diminish a focusing error. When light enters an information recording plane of an optical disk in the form of a single beam, a change in the position of the intensity distribution of light arriving at the light receiving area of the photodetector upon reflection from a pit according to the push-pull method is detected, whereby a correction is made to a tracking position. In particular, of these signals, a tracking error signal is vulnerable to stray light. Hence, it is preferable to generate a tracking error signal from a signal arriving at the light receiving area 251 of the first photodetector. As shown in FIG. 21, the light receiving areas 251 and 252 each are further made up of four or more segments, and the quantity of light arriving at each of the segments is computed, to thus detect a required (error) signal. The number of segments is not limited to four but may also be set to five or more. In addition, the number of segments can also be made commensurate with the number of types of signals to be detected; for instance, a disk tilt signal, a lens shift signal, and the like.

FIGS. 19A and 19B show a schematic plan view, as a seventh embodiment, of a hologram element in which the third region is further divided into a plurality of segments. A hologram element 230 shown in FIG. 19A is divided into a first region 231 having high transmissivity, a second region 232, and a third region 233 as in the first embodiment. In the present embodiment, the third region 233 is further made up of three divided regions 233a, 233b, and 233c. The number of regions into which the third region is to be separated is not limited to three and can be two or four or more, and the third regions can also have a distribution of transmissivity that continuously changes from the transmissivity of the first region to the transmissivity of the second region. When transmissivity in the third regions is not uniform, the transmissivity T3 is average transmissivity achieved in the third region.

In the present embodiment, the hologram element has the second region set in agreement with light diffracted by the single beam method, and the second region is arranged so as to include the optical axis of the signal light and the optical axis of the stray light. The essential requirement for the hologram element 230 is that the point of center of the second region 232 should match the optical axes. In the present embodiment, the second and third regions are not limited to a configuration where analogous squares are distributed with their center points substantially aligned with each other, but can also assume a concentric pattern or a shape including a polygon or an arbitrary curve. Further, an outer edge of each of the regions can also adjoin an outer edge of another region.

In FIG. 19A, transmissivity of the first region 231 is taken gas T1, and transmissivity of the second region 232 is taken as T2. Further, in the third regions, transmissivity of the region 233a is taken as Tr1; transmissivity of the region 233b is taken as Tr2; and transmissivity of the region 233c is taken as Tr3. Provided that a relationship of transmissivity achieved on the conditions is T1>Tr3>Tr2>Tr1>T2, transmissivity becomes greater stepwise toward outer edges with reference to the second region, whereby diffraction of intensity-modulated stray light, which would otherwise arise in an interface between regions, can preferably be prevented. So long as transmissivity is designed in such a way that transmissivity is finely changed in a stepwise manner by additionally dividing the third regions or such that transmissivity is continuously changed, an inhibition effect will be further enhanced.

A method for setting a value of transmissivity difference between regions having different transmissivity values when the third region is split into a plurality of divided regions will now be described. By way of example, a hologram element 235 is divided into regions such as those shown in FIG. 195, and a third region 238 is further divided into regions 238a and 238b, which are assumed to have the same width “d.” In relation to the change in transmissivity, the hologram element can also be considered in the same manner as in the first embodiment. A Gaussian approximation distribution shown in FIG. 3B can be adopted. Therefore, in the configuration, when T2/T≦0.1 is attained, the maximum normalized value of transmissivity difference between regions having different transmissivity values is 0.6=(Tr2−Tr1)/T1. Therefore, it is preferable to set a normalized transmissivity difference between regions having different transmissivity values with one interface therebetween to a value ranging from over 0 to 0.7; more preferably, a value ranging from over 0 to 0.6. Further, when the third region is divided into three or more divided regions in such a way that transmissivity changes stepwise, a normalized transmissivity difference can be made smaller than 0.6 with an increase in the number of divided regions into which the third regions is separated, and the changes more approximate to the change in Gaussian distribution.

For instance, it is preferable to design a value of transmissivity in such a way that T1 comes to 80% or more, whereby signal light can be efficiently guided to a photodetector; and it is more preferable that T1 comes to 90% or more. Preferably, stray light arriving at the photodetector can further be reduced by making transmissivity T2 of the second region approximate to zero.

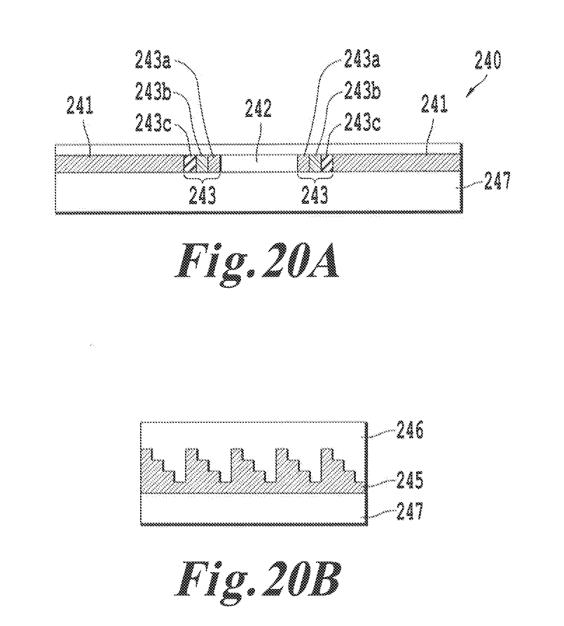

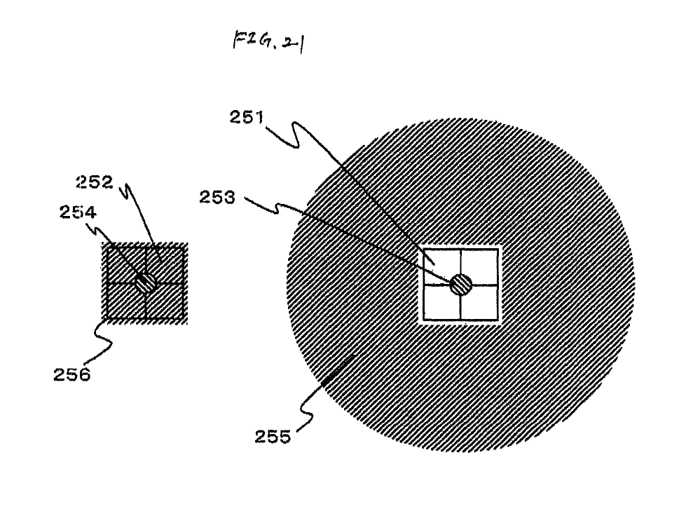

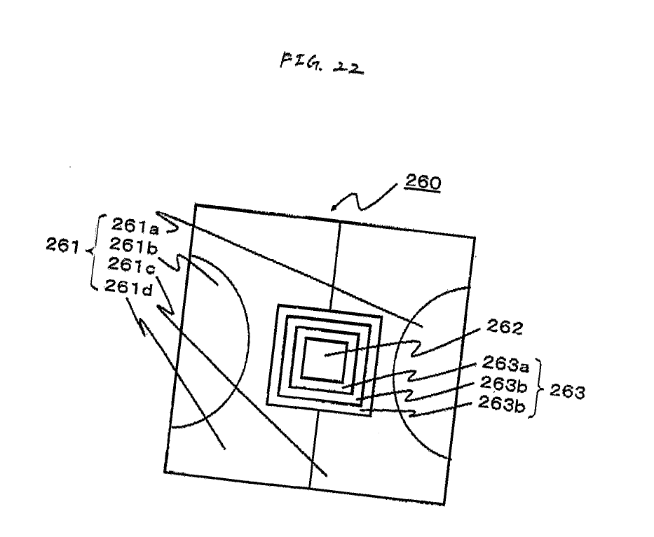

A specific configuration for activating the hologram element will now be described. FIG. 20A shows a schematic cross-sectional view of a hologram element 240 that is to be fabricated in a region exhibiting diffraction. FIG. 20A is a schematic cross-sectional view cut along a straight line passing through the point of center of a second region as indicated by X-X′ shown in FIG. 19A. Each of the regions assumes a diffraction grating structure having a convexoconcave periodic cross sectional profile. In this case, a first region 241, a second region 242, and three divided regions 243a, 243b, and 243c making up a third region 243 are built from diffraction gratings having a structure in which diffraction is stepwise effected through diffracting action and in which transmissivity of light guided to the first light receiving area changes from one region to another; that guide the light to the photodetector; and that have different transmissivity levels. The first order is used for the order of diffracted light guided to the first light receiving area. However, the order of the diffracted light is not limited to the first order. Higher-order diffracted light, such as the second-order diffracted light and the third-order diffracted light, any negative order diffracted light, such as the −1^{st}-order diffracted light, or a combination of diffracted light beams, can also be used. The second region 242 has the lowest transmissivity T2 as mentioned above, and transmissivity is designed so as to become higher, within the plane of the hologram element, from the second region toward the first region, i.e., toward the outside. In particular, preferred transmissivity T2 of the second region is zero.

Transmissivity, which acts as the 1^{st}-order diffraction efficiency of light diffracted by the diffraction grating structures of the respective regions, may also be realized by changing and adjusting the depth of indentations of a diffraction grating structure made in the surface of each of the regions, the refractive index of a convexoconcave grating material, and a ratio (a Duty ratio) of width of indentations and projections in a grating. As mentioned above, the second region are preferably provided with a structure for inhibiting incidence of light on the photodetector (T2=0). Transmissivity can be adjusted by a combination of the second region with a structure exhibiting light reflecting, absorbing, and diffracting actions. The structure can also adapt to the third regions that permit entry of light in reduced quantity to the first photodetector as well as to the second region; and adjusts transmissivity of light entering the photodetector by adjusting a shape of the structure, thereby enabling performance of gradation in a manner that transmissivity stepwise changes within a plane. A multilayer film in which a high refractive index material and a low refractive index material are periodically stacked, a cholesteric liquid-crystal material, and the like, are used as the structure exhibiting the light reflecting action. A diffraction grating having periodic indentations and protrusions can be utilized in the second region as an element exhibiting a diffracting action. However, so long as an outgoing direction of light diffracted by the diffraction grating is greatly different from the direction of the first photodetector, stray light can be reduced much. The cross sectional profile of the diffraction grating structure is not limited to a rectangular shape. As long as the cross sectional profile assumes the shape of a saw blade (a blaze shape), transmissivity (the 1^{st}-order diffraction efficiency) can be enhanced, which in turn preferably enhances an optical efficiency. When the diffraction grating assumes a blaze shape, transmissivity can also be adjusted by changing the number of steps of a stair-like structure making up the blaze shape.

The second region 242 has a diffraction grating structure as mentioned above and may also exhibit an action for diffracting light in a direction differing from the direction of the photodetector. In FIG. 20A, the second region can also be integrated with; for instance, a transparent substrate 247, to thus embody a structure that allows rectilinear passage of incident light without diffraction, to thus prevent incidence of light on the first photodetector. In this case, there is no necessity for a diffraction grating structure, and productivity is preferably enhanced.

FIG. 20B is a schematic cross-sectional view showing an example diffraction grating structure. For the sake of convenience, an interface of the diffraction grating is depicted by a straight line in FIG. 20A. In an actual cross section, the first region 241 and the third region 243 that exhibit at least a diffracting action become a combination of the first optical material 245 making up a hologram element and the second optical material 246 differing in refractive index from the first optical material, as shown in FIG. 20B. Each of the first optical material 245 and the second optical material 246 may be an isotropic material, a birefringent material exhibiting refractive-index anisotropy, or a combination thereof. The minimum requirement for the first and second optical materials is to have a structure that exhibits a different refractive index with respect to light in a specific direction of polarization. In a case where a birefringent material is used for the first optical material 245 and where an isotropic material is used for the second optical material 246, indentations and protrusions in the surface of the diffraction grating are smoothly filled with an isotropic material having a refractive index substantially equal to an ordinary refractive index (no) or an extraordinary refractive index (ne) of a birefringent material. An acrylic material, an entiol-based material, an epoxy-based material, and the like, can also be used for a filling material. In the example shown in FIG. 20B, the cross-sectional profile of the diffraction grating structure is realized as a stair-like pseudo blaze shape. However, the cross-sectional profile may also be a non-stair-like blaze shape or a binary, convexoconcave shape. So long as the cross-sectional profile assumes a blaze shape or a pseudo blaze shape, the diffraction efficiency of the +1^{st}-order diffracted light is increased, whereby an optical efficiency can preferably be increased. Further, among blaze shape, a pseudo blaze shape is preferably easy to make.

The hologram element 240 having a diffraction grating structure, such as that mentioned above, in which the combination of the first optical material 245 and the second optical material corresponds to a combination of a birefringent material and an isotropic material, is disposed at the position designated by reference numeral 18e in the optical head device 10c shown in FIG. 17. At this time, the outgoing light from the light source 11 is linearly polarized light, and the hologram element 18e (=the hologram element 240) is arranged so as to exhibit high rectilinear transmission efficiency in all of the regions in connection with the linearly polarized light in the forward path. In short, the hologram element is arranged in a direction where the linearly polarized light in the forward path matches either an ordinary refractive index (no) or an extraordinary refractive index (ne) of the birefringent material and the refractive index of the isotropic material and does not undergo a change in refractive index. When the quarter wavelength plate 19 that converts, from linearly polarized light into circularly polarized light, polarized light traveling toward the optical disk 16 along the forward path is interposed in an optical path between the hologram element 18e and the objective lens 15, the light reflected from the optical disk 16 along the return path again passes through the quarter wavelength plate 19, to thus become linearly polarized light orthogonal to the linearly polarized light in the forward path. When the light converted into linearly polarized light in the return path as mentioned above enters the hologram element 18e, the light undergoes a change in refractive index at an interface between a birefringent material and an isotropic material making up the diffraction grating structure. Light in the return path undergoes diffraction while the quantity of light is changed by transmissivity the first-order diffraction efficiency) that is different with respect to each region in the hologram element 18e.

So long as the optical material making up the hologram element is made of a combination of a birefringent material and an isotropic material as mentioned above, light in the forward path can efficiently be guided to the optical disk even when the hologram element is disposed in an optical path common between the forward path and the return path. Although the signal light reflected from the optical disk 16 is illustrated in FIG. 17 so as to enter the hologram element and rectilinearly travel, the drawing is a schematic view for the sake of convenience. In reality, the optical system is designed and arranged in alignment with the direction of diffraction. For instance, when a hologram element made up of a birefringent material and an isotropic material is disposed at the position 18e, the traveling direction of light can be adjusted by diffracting the light in the return path reflected from the optical disk, so that an optical head device can be materialized without arrangement of the beam splitter 13.

FIG. 22 shows a schematic plan view of a hologram element 260 of an eighth embodiment. Light exit from a first region 261, a second region 262, and divided regions 263a, 263b, and 263c of a third region 263, thereby arriving at a light receiving area of the first photodetector. Transmissivity T1, T2, Tr1, TR2, and Tr3 of the respective regions is defined as a relationship of T2<Tr1<Tr2<Tr3<T1 as in the case of the seventh embodiment. In the third embodiment, the first region 261 is further divided into four regions 261a, 261b, 261c, and 261d as shown in FIG. 22. All beams of the signal light exiting the four regions 261a, 261b, 261c, and 261d arrive at, while being converged at, the light receiving area of the first photodetector. However, the signal light is set in such a way that the beams of the signal light are converged at different positions within the light receiving area as will be described later. The transmissivity T1 of the first region 261 is defined as a ratio of light arriving at the first photodetector after having undergone diffraction to the signal light entering the first region as in the sixth and seventh embodiments.

The transmissivity T1 of the first region 261 is assumed to be substantially uniform. In this case, a change in the quantity of light arriving at the first photodetector within the light receiving area become easy to detect. Although the transmissivity T1 is substantially uniform in the first region 261, each of the regions 261a, 261b, 261c, and 261d may also have different transmissivity. However, in this case, transmissivity is determined in such a way that the quantity of stray light arriving at the light receiving area of the first region as a result of decreases occurrence of diffraction of intensity-modulated light for reasons of a difference in transmissivity resulting from adjoining of light receiving areas 261a, 261b, 261c, and 261d. A sufficient optical efficiency is acquired, so long as the area ratio of the first region 261 to the effective region of signal light entering the hologram element 260 comes to 70% or more. For instance, depending on the type of a signal to be generated, it is better to adjust the divided regions of the first region 61 in such a range that the divided regions 261a and 261b account for about 10 to 30% and that the divided regions 261c and 261d account for about 20 to 30%.

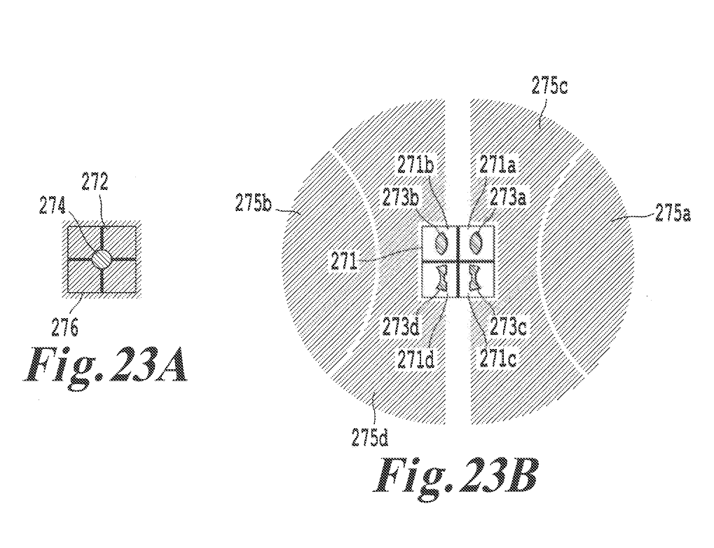

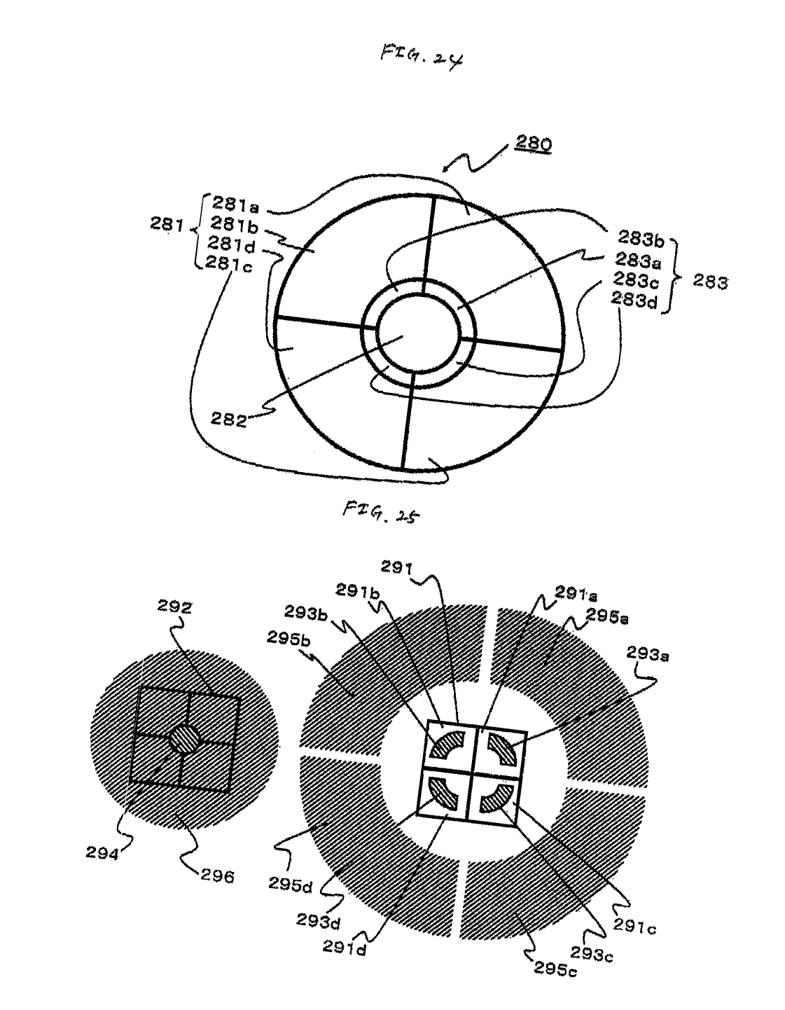

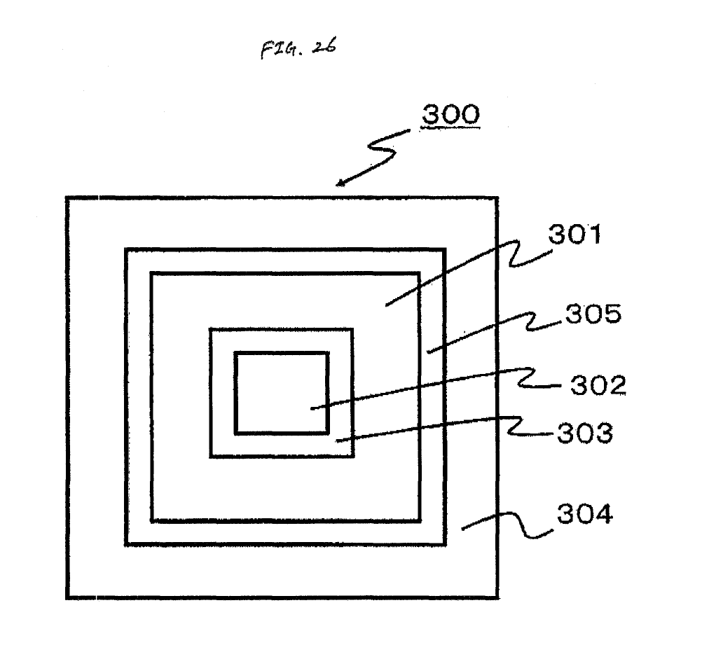

By way of example, a schematic plan view of FIG. 23 shows the state of light arriving at the photodetector 17 when the hologram element 260 is arranged at position 18f in the optical head device 10c shown in FIG. 17. FIG. 23 shows states of signal light and stray light arriving at the two photodetectors after having passed through the hologram element; particularly, a light receiving area 271 of a first photodetector and a light receiving area 272 of a second photodetector. Likewise, the photodetector may also be embodied by only the first photodetector, or there may be a mode in which a first photodetector and a second photodetector detect two beams of signal light.

Beams of signal light, which enter the first region 261 and exit from the divided regions 261a, 261b, 261c, and 261d, are diffracted toward the light receiving area 271 of the first photodetector. However, in relation to the directions of diffraction of the signal light exiting the respective divided regions, the respective beams of signal light arrive at, while being converged on, inside of the respective divided segments 271a, 271b, 271c, and 271d in the light receiving area 271. A positional relationship among segments in the light receiving area 271 to the respective divided regions of the first region can be determined by designing of diffraction gratings of the respective divided regions 261a, 261b, 261c, and 261d of the first region and arrangement of an unillustrated cylindrical lens in an optical path between the hologram element 18f (=the hologram element 260) of the optical head device 10c and the first photodetector. Therefore, the positional relationship between the signal light converged on positions 273a, 273b, 273c, and 273d shown in FIG. 23 and the respective segments 271a, 271b, 271c, and 271d of the light receiving area 271 is one example. As mentioned above, as a result of the luminous flux consisting of the beams of signal light exiting from the first region 261 arriving at the light receiving area 271 without straddling the respective segments as mentioned above, the accuracy of a tracking error signal that is produced by computing quantities of light received by the respective segments is enhanced, whereby signal processing with superior quality becomes feasible. As shown in FIG. 23, the respective segments 271a, 271b, 271c, and 271d of the light receiving area 271 are not limited to a layout where they adjoin to each other, as shown in FIG. 23, but may also be arranged in a discrete manner.

Meanwhile, when stray light enters the first region 261 and the third region 263 of the hologram element 260, the stray light does not come into a focus at the position of the light receiving area 71 of the first photodetector. Hence, stray light exit from the respective divided regions 261a, 261b, 261c, and 261d of the first region 261 and arrive at the respective regions 275a, 275b, 275c, and 275d. As in the first and second embodiments, transmissivity change from the first region 261 to the second region 262 achieved within a plane of the hologram element 260 becomes smooth as a result of presence of the third region 263, so that diffraction of intensity-modulated light can be inhibited; hence, wraparound of stray light arriving at the light receiving area 271 can be reduced.

Although the number of segments into which the first region 262 of the hologram element 260 is to be divided is illustrated as four, the number of segments is not limited to four but may also be five or more. Moreover, the number of segments of the light receiving area 271 of the first photodetector is also not limited to four but may also be five or more according to the type of a signal to be processed or a method for processing the signal. The light receiving area of the first photodetector is made up of a plurality of segments P1 to Pn (an integer of n≧4). When the first region is divided into a plurality of regions S1 through Sm (an integer of m≧4) of arbitrary shapes, a relationship of m≧n stands, and arrival of signal light at least respective segments P1 to Pn is made possible. Alternatively, for instance, a luminous flux consisting of a plurality of beams of signal light can also arrive at one divided region of a light receiving area like arrival of signal light exiting regions S1 and S2 at the region P1.

Light exiting the second region 262 of the hologram element 260 travels in a direction differing from the direction of the first photodetector as in the sixth and seventh embodiments. As shown in FIG. 22, a second photodetector may also be positioned in a direction where the light exiting from the second region 262 travels. The signal light 274, which has exited from the second region 262 and undergone convergence, arrives at the second light receiving area 272, and stray light 275 also arrives at the same location. However, for instance, the second photodetector can also be utilized for the purpose of generating and processing a signal of a kind which is less vulnerable to interface of signal light with stray light.

A schematic plan view of a hologram element 280 is shown in FIG. 24 as a modification of the eighth embodiment. The hologram element 280 is made up of a second region 282 including an optical axis, and a first region 281 and a third region 283. Transmissivity levels T1, T2, and T3 of respective regions where the signal light enters and exits to the first photodetector also assume a relationship of T1>T3>T2, in the same manner. As in the case of the hologram element 260, the first region 281 is divided into four regions. A luminous flux that exits as a result of incident signal light on the first region 281 undergoing diffraction on divided regions 281a, 281b, 281c, and 281d is set so as to arrive at respective divided regions 291a, 291b, 291c, and 291d of a light receiving area 291 of the first photodetector shown in FIG. 25. As in the second embodiment, the third region 283 is further divided, and there may also be configured in such a way that transmissivity changes stepwise from a first region 281 toward a second region 282 within the plane of the hologram element 280.

The divided regions 281a, 281b, 281c, and 281d of the first region 281 may also differ from each other in terms of a shape and an area. However, so long as the divided regions are set so as to become essentially equal to each other in terms of an area and to become substantially analogous to each other as shown in FIG. 24, signal processing intended for changes in quantities of signal light 293a, 293b, 293c, and 293d arriving at respective segments 291a, 291b, 291c, and 291d of the light receiving area 291 preferably becomes easy. The transmissivity T1 of the first region 281 is substantially uniform. In this case, optical signal processing for a change in light quantity becomes preferably easy. It is not limited that the transmissivity T1 of the first region 281 is substantially uniform. The transmissivity T1 may also have a different transmissivity level for each of the regions 281a, 281b, 281c, and 281d. The third region 283 is interposed, within a plane of the hologram element 280 as shown in FIG. 24, between the first region 281 and the second region 282 and is provided with transmissivity that is approximately intermediate between the transmissivity levels of the first and second regions, thereby diminishing the quantity of wraparound light in the light receiving area 291 of the first photodetector by means of diffraction of intensity-modulated light. The third region 283 can also be divided into 283a, 283b, 283c, and 283d in shapes, such as those shown in FIG. 24. The transmissivity of the third region 283 may also be even and substantially uniform or differ among the regions 283a, 283b, 283c, and 283d.

Stray light entering the first region 281 and the third region 283 of the hologram element 280 exit after having undergone diffraction, to thus travel toward the first photodetector. However, the stray light does not come into a focus and, hence, arrive at positions outside the light receiving area 291, as in the case of the regions 295a, 295b, 295c, and 295d. Since the stray light entering the second region 282 travels in a direction different from the direction of the first photodetector, the stray light arrives at the light receiving area 291 of the first photodetector while being reduced in quantity or fails to arrive at the light receiving area. Therefore, interference of signal, light with stray light in the light receiving area 291 is inhibited, so that the signal-to-noise ratio can be increased.

The light exiting from the second region 282 of the hologram element 280 travels in a direction different from the direction of the first photodetector. Because of the foregoing reasons, a second photodetector may also be disposed in the direction in which light exiting from the second region 282 travels, as shown in FIG. 25. Signal light 294, which has exited from the second region 282 and undergone convergence, arrives at a second light receiving area 292, and stray light 296 also arrives at the region. However, for instance, the second photodetector can also be utilized for the purpose of generating and processing a signal of a kind which is less vulnerable to interference of signal light with stray light.

The embodiment of the hologram element of the present invention, which is made up of three regions; namely, the first region, the second region, and the third region, has been described thus far. The photodetector 17 provided in the optical head device 10c has been described by reference to the embodiment in which one or two photodetectors are provided; however, the photodetector is not limited to that embodiment. Light exiting from diffraction gratings of respective regions making up a hologram element, and the like, is not limited primarily to +1^{st}-order diffracted light. −1^{st}-order diffracted light or high-order diffracted light, such as ±2^{nd}-order diffracted light or more can also be generated. Moreover, a diffraction angle of diffracted light and the amount of diffracted light (transmissivity) can be adjusted by means of a material and a shape that make up diffraction gratings. Consequently, for instance, when the diffraction gratings making up the first region generate the +1^{st}-order diffracted light or −1^{st}-order diffracted light, photodetectors may also be provided for respective beams of diffracted light traveling in two directions, or photodetectors may also be provided in every direction in which transmitted light or generated diffracted light travels.

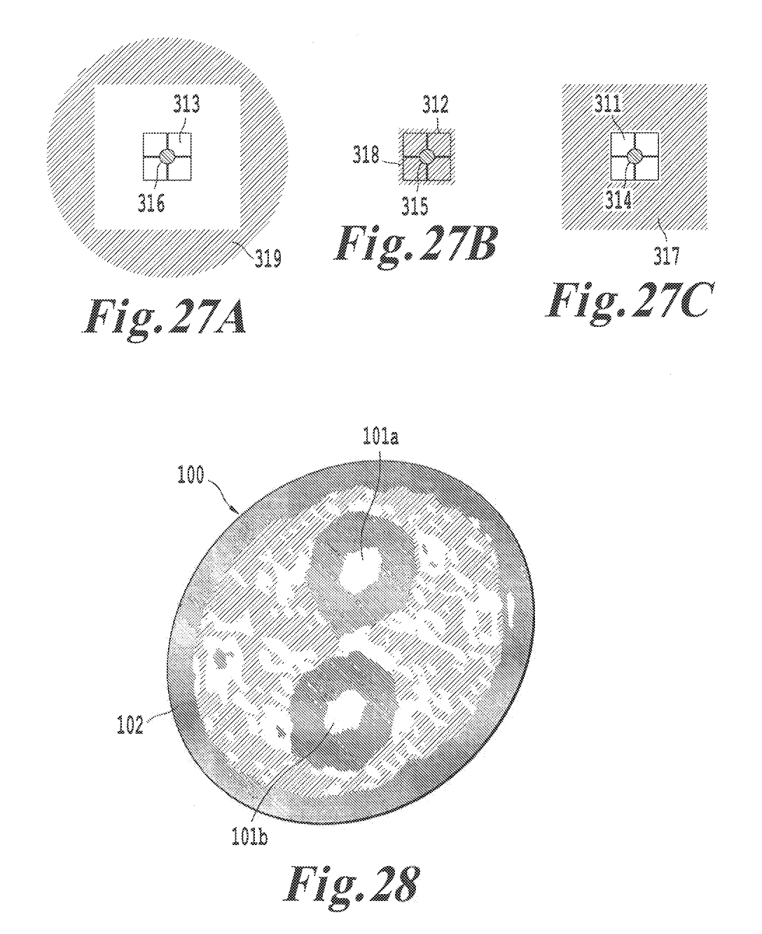

In contrast with the configurations of the hologram elements described thus far, a hologram element 300 shown in FIG. 26 may also be employed as; for instance, a ninth embodiment. The hologram element 300 is made up of a first region 301, a second region 302, a third region 303, a fourth region 304, and a fifth region 305, Outer edges of the respective areas are square, but the outer edge may also assume another shape, such as a circular shape, an oval shape, and a polygonal shape, and may also differ with respect to each region. An outer edge of the first region is located inside where the outer edge does not contact an outer edge of the fifth region or an inside area where the outer edge contact the portion of the outer edge of the fifth. The outer edge of the fifth region is located inside the outer edge of the fourth region or at an inside area where the region contacts a portion of the fourth region. In this case, as shown in FIG. 27, the photodetector 17 provided in the optical head device 10c has three photodetectors namely, a light receiving area 311 for a first photodetector, a light receiving area 312 for a second photodetector, and a light receiving area 313 for a third photodetector. As will be described later, the light exiting from the first region 301 and the third region 303 primarily arrive at the light receiving area 311 of the first photodetector, and light exiting from the fourth region 304 and the fifth region 305 primarily arrive at the light receiving area 313 of the third photodetector. Moreover, light exiting from the second region 302 primarily arrives at the light receiving area 312 of the second photodetector.

Ratios of light quantity arriving at the light receiving area 311 of the first photodetector after having undergone diffraction to light quantities acquired as a result of signal light entering the first region 301, the second region 302, the third region 303, the fourth region 304, and the fifth region 305 of the hologram element 300 are assumed to be T1, T2, T3, T4, and T5, respectively. There stand a relationship of T1>T3>T2 and a relationship of T1≧T5≧T4. It is particularly preferable that T2 assumes a value of zero. Ratios of light quantity arriving at the light receiving area 313 of the third photodetector after having undergone diffraction to light quantities acquired as a result of signal light entering the first region 301, the second region 302, the third region 303, the fourth region 304, and the fifth region 305 of the hologram element 300 are assumed to be T1′, T2′, T3′, T4′, and T5′, respectively. There stand a relationship of T4′>T5′>T1′≧T3′≧T2′. It is particularly preferable that there should stand a relationship of T1′=T3′=T2′=0. When T1′=T3′=T2′=0, T4′ is normalized to one in connection with the relationship of T4′>T5′>T1′. T5′/T4′ may assume a uniform value, such as that approximate to the Gaussian distribution shown in FIG. 3A, and the fifth region 305 may also be further divided into “m” regions R1 to Rm (an integer of m≧2), to thus exhibit a distribution of light quantity approximate to the Gaussian distribution.

When three photodetectors detect the signal light, an area of the first region 301, an area of the second region 302, and an area of the fourth region 304 are adjusted with respect to an effective area where signal light enters the hologram element 300, depending on the types of signals generated as a result of detection of the signal light and an optical system. It is preferable that the second region 302 should be fallen within range from 1% to 30% of the effective region as in the first embodiment. The first region 301 subjects incident signal light to diffraction, to thus cause the light to arrive at the first photodetector. The fourth region 304 subjects incident signal light to diffraction, to thus cause the light to arrive at the third photodetector. Hence, it is better to adjust the areas of the first and fourth regions so as to assume an area ratio of 5% or more of the effective region. As mentioned above, in view of the functions of the photodetector, such as detection of a reproduced signal during reproduction of data from an optical disk and processing for generating a plurality of error signals, provision of three photodetectors results in a reduction in load per photodetector; hence, an advantage of the ability to avoid complication of a control circuit can be yielded.

The signal light exited from the first region 301 and the third region 303 are converged, to thus arrive at a region 314 within the light receiving area 311 of the first photodetector. Meanwhile, the stray light is not converged, to thus arrive at a region 317 outside the light receiving area 311 of the first photodetector, and diffraction of intensity-modulated light can be inhibited, and hence interference of signal light with stray light in the light receiving area 311 can be diminished. It may also be preferable that light exiting from the fourth region 304 and the fifth region 305 should be caused to arrive at the light receiving area.

The signal light exited from the fourth region 304 and the fifth region 305 is converged, to thus arrive at a region 316 in the light receiving area 313 of the third photodetector that is different from the directions of the first and second photodetectors. Meanwhile, stray light is not converged, to thus arrive at a region 319 outside the light receiving area 313 of the third photodetector, and diffraction of intensity-modulated light can be inhibited; hence, interference of the signal light with the stray light in the light receiving area 313 can be diminished. Further, the signal light exited from the second region 302 is converged, to thus arrive at a region 318 in the light receiving area 312 of the second photodetector. Although the stray light also arrives at the region 318, the hologram can be utilized; for instance, for the purpose of performance of processing for generating a type of signal that is less vulnerable to interference of signal light with stray light. By virtue of the plurality of photodetectors, a signal other than a reproduced (RF) signal, a tracking error signal, and a focus error signal; for instance, a disk tilt signal, a lens shift signal, and the like, can be generated, and an optical head device exhibiting superior reproduction quality can be realized.

Examples of the present invention will hereinafter be described in detail.

### First Example

Transmissivity levels of the respective regions achieved at a wavelength of 405 nm are set by the configuration of the optical attenuation device 40 shown in FIG. 5A. Transmissivity levels of the respective regions are adjusted by stacking, by means of vacuum deposition, a multilayer film consisting of SiO2 ard Ta2O5 on a glass substrate and changing the total thickness of the film with respect to each region. An antireflection film is stacked on the first region 41 requiring particularly high transmissivity, to thus achieve transmissivity nearly approximate to about 100%. Further, an Al film is stacked on the glass substrate in the regions 42 and 44 whose transmissivity levels are about 0%, by means of vacuum deposition. Through the foregoing method, a transmissivity level is changed on a per-region basis, such as transmissivity of the first region 41=about 100%; transmissivity levels of the third region (the region R3) 43c, 45c=about 90%; transmissivity levels of the third regions (the region R2) 43b, 45b=about 50%; transmissivity levels of the third regions (the region R1) 43a, 45a=about 10%; and transmissivity levels of the second regions 42 and 44=about 0%.

An effective diameter of signal light entering the optical attenuation device 40 is set to about 4 mm; a diameter of the second region is set to about 800 μm; and widths of the respective divided regions R1, R2, and R3 making up the third region are set to 75 μm, 50 μm, and 75 μm, respectively.

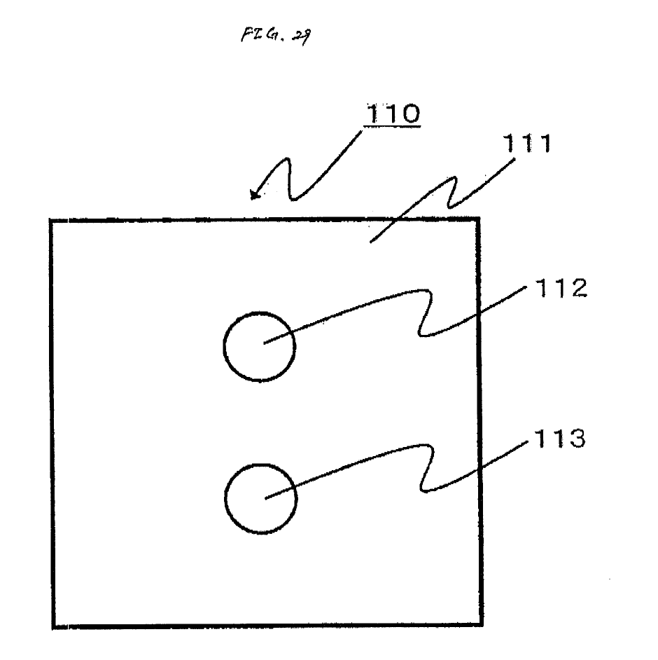

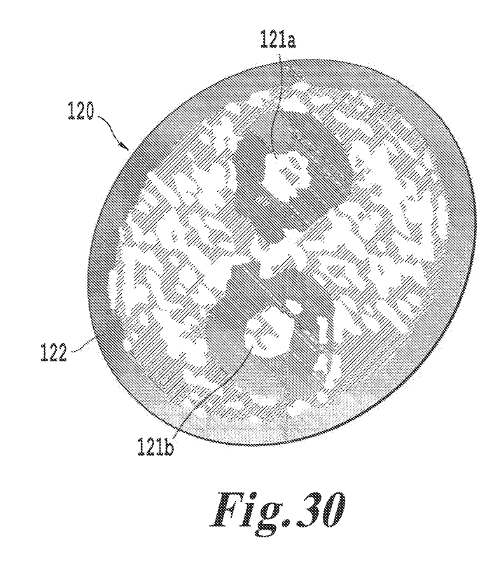

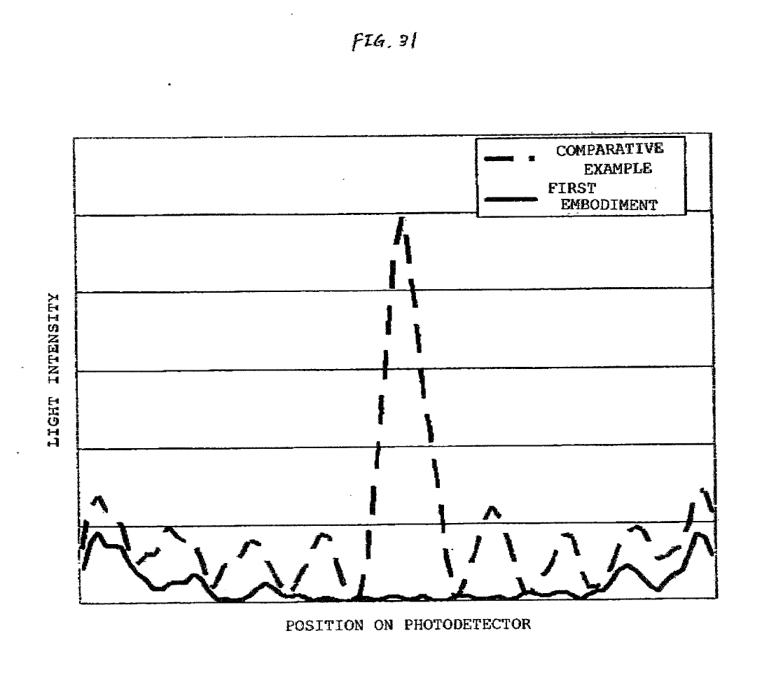

FIG. 28 is a view showing, in the form of a wave engineering simulation, the intensity of stray light of the main beam received by the photodetector 17 when the optical attenuation device 40 is disposed at the positions 18a or 18b in the optical head device shown in FIG. 1, wherein a much intensely colored area shows a position of higher light intensity. The regions 88 and 89 shown in FIG. 9 correspond to regions 101a and 101b shown in FIG. 28. Thus, stray light corresponding to the sub-beam light receivers in the regions 101a and 101b can sufficiently be reduced. Moreover, a solid line in FIG. 31 indicates the intensity distribution of stray light taken along a cross section passing through the center of the regions 101a and 101b. It is also understood from the drawing that the stray light on the photodetector can be reduced.

An overlap between signal light and stray light arriving at a region that is to serve as a light receiving area of a photodetector is evaluated by use of the following equation.

I=∫I1·I2dS

where I1 designates the intensity of signal light and where I2 designates the intensity of stray light. The product of I1 and I2 is integrated by an area, to thus derive I. Specifically, as the value of I becomes larger, the quantity of signal light and stray light arriving at the light receiving area while overlapping each other is large; hence, the signal light is vulnerable to interference. When the light receiving area for one sub-beam is evaluated, “I” assumes a value of 1.9% provided that the value of “I” achieved when the optical attenuation device 40 is not disposed is taken as 100%.

### Second Example

In the configuration of the optical attenuation device 40 that is identical with that of the first example, the effective diameter of signal light entering the optical attenuation device 40 is set to about 4 mm; the diameter of the second region is set to about 800 μm; and widths of the respective divided regions R1, R2, and R3 making up the third region are set to 495 μm, 330 μm, and 495 μm, respectively. The other conditions for transmissivity are the same as those of the first embodiment.

At this time, an overlap between signal light and stray light, which arrive at the light receiving area of the photodetector, is evaluated in the same manner as mentioned previously. As a result, “I” assumes a value of 1.4%.

### Third Embodiment

Likewise, in the configuration of the optical attenuation device 40, an effective diameter of signal light entering the optical attenuation device 40 is set to about 4 mm; a diameter of the second region is set to about 560 μm; and widths of the respective divided regions R1, R2, and R3 making up the third region are set to 75 μm, 50 μm, and 75 μm, respectively. A transmissivity level is changed on a per-region basis, such as transmissivity of the first region 41=about 100%; transmissivity levels of the third region (the region R3) 43c, 45c=about 36%; transmissivity levels of the third regions (the region R2) 43b, 45b=about 16%; transmissivity levels of the third regions (the region R1) 43a, 45a=about 4%; and transmissivity levels of the second regions 42 and 44=about 0%.

At this time, an overlap between signal light and stray light, which arrive at the light receiving area of the photodetector, is evaluated in the same manner as mentioned previously. As a result, “I” assumes a value of 2.2%.

### Comparative Example

As shown in FIG. 29, a case where there is employed an optical attenuation device 110 made up of a first region 111 having a transmissivity level of about 100% and second regions 112 and 113 having a transmissivity level of 0% will now be described. The optical attenuation device is analogous to its counterpart of the embodiment except that the third region which is to assume an annular shape in the embodiment is divided along its widthwise direction into a second region and a first region. Specifically, the diameter of the second region is about 1 mm. In connection with a manufacturing method, the first region 111 having a transmissivity level of about 100% is formed on a glass substrate from a multilayer film consisting of SiO2 and Ta2O5, and the regions 112 and 113 having a transmissivity level of about 0% is formed from an Al film as in the embodiment.

FIG. 30 is a view showing, in the form of a wave engineering simulation, the intensity of stray light of the main beam received by the photodetector 17 when the optical attenuation device 110 is disposed at the position 18a or 18b in the optical head device shown in FIG. 1, wherein a much intensely colored area shows a position of higher light intensity. The regions 88 and 89 shown in FIG. 9 correspond to regions 121a and 121b shown in FIG. 30. Thus, stray light corresponding to the sub-beam light receivers in the regions 121a and 121b is understood to wrap around the inside of the regions 121a and 121b by means of diffraction of intensity-modulated light. Moreover, a broken line in FIG. 31 indicates the intensity distribution of stray light taken along a cross section passing through the center of the regions 121a and 121b, wherein high intensity appears particularly at the center of the regions 121a and 121b. It is also understood from the drawing that the stray light on the photodetector cannot sufficiently be reduced under influence of wraparound of light induced by intensity modulation arising among the regions having different transmissivity levels.

The value of “I” used for evaluating an overlap between signal light and stray light comes to 8.7%, as in the first embodiment, provided that the value of “I” achieved when the optical attenuation device 40 is not disposed is taken as 100%. When compared with the optical attenuation device 40 that is provided with the third region as in the embodiment, stray light is not greatly reduced. Therefore, stray light interferes with sub-beams of signal light, thereby causing crosstalk responsible for noise. In particular, in a detection system where a photodetector is divided into a plurality of light receiving areas and where a signal pertaining to a difference among quantities of light arriving at respective divided areas is detected as an error signal, an error rate of a signal generated as a result of an increase in the value of “I” is also increased. Therefore, in contrast with the comparative example, a result of the embodiment makes it possible to expect a great reduction in error rate.

### Fourth Embodiment

By means of configuration of the hologram element shown in FIG. 14A, there is set transmissivity the first-order diffraction efficiency) for a wavelength of 405 nm by means of which the first-order diffracted light is achieved in each of the regions. The respective regions are formed by making, on the class substrate, polymer liquid crystal material having an ordinary refractive index (no) of 1.55 and an extraordinary refractive index (ne) of 1.60 with respect to light of 405 nm and making pseudo-blaze-shaped diffraction gratings with a stair-shaped cross section through photolithography and etching. The first region and divided regions of third regions are processed in such a way that the shape of a diffraction grating structure changes with respect to each region, thereby changing first-order diffraction efficiency stepwise. Subsequently, a convexoconcave plane thus formed in the shape of a diffraction grating is filled with an isotropic acrylic resin having a refractive index of 1.55 substantially equal to the ordinary refractive index of polymer liquid crystal, and the plane is then planarized. By adoption of such a configuration, there is obtained a hologram element that exhibits high transmissivity in relation to light polarized in a direction of ordinary light of the polymer liquid crystal and that has a function of diffracting light with respect to light polarized in the direction of extraordinary light.

By changing the grating shape of the diffraction gratings, the first-order diffraction efficiency of the first region 141 comes to 95%; the first-order diffraction efficiency of the third regions 143a, 145a, and 147a comes to 85%; the first-order diffraction efficiency of the third regions 143b, 145b, and 147b comes to 50%; and the first-order diffraction efficiency of the third regions 143c, 145c, and 147c comes to 10%. By means of not adopting the diffraction grating structure, the second region has a first-order diffraction efficiency of 0%. An effective diameter of signal light entering the hologram element is taken as about 4 mm; the diameter of the second region is taken as about 800 μm; and widths of the respective divided regions R1, R2, and R3 making up the third region are taken as 75 μm, 50 μm, and 75 μm, respectively.

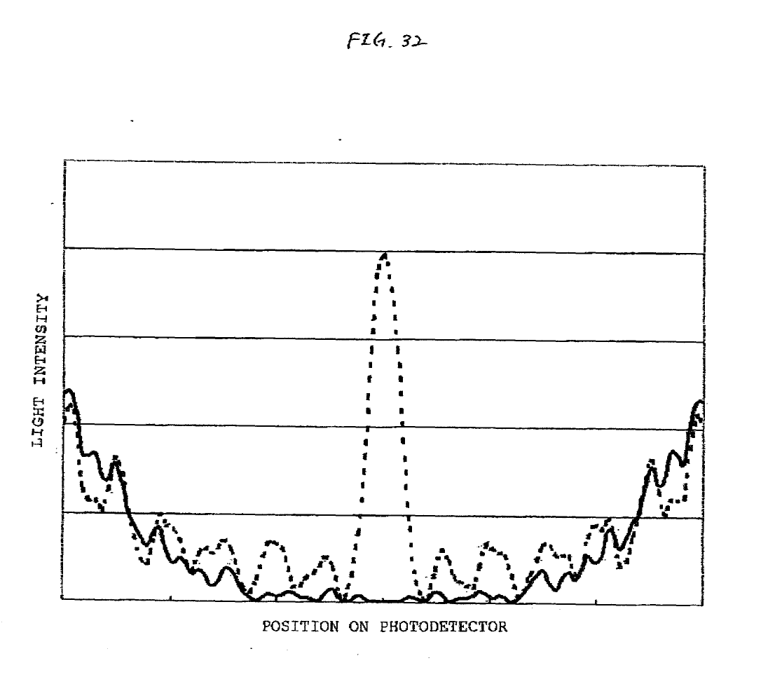

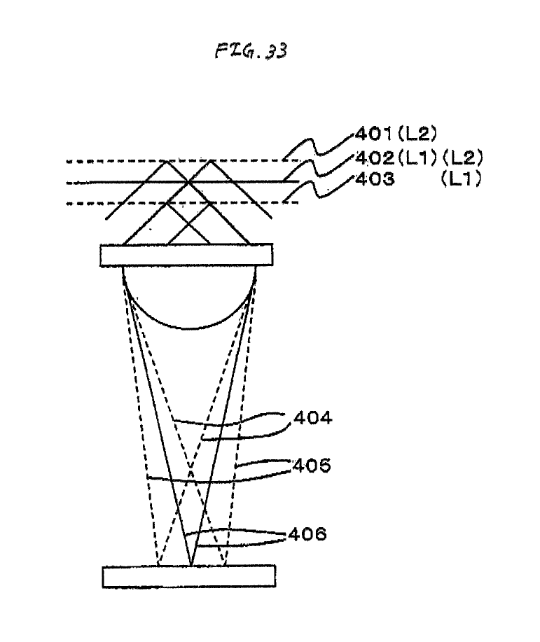

At this time, the distribution of light intensity achieved in the light receiving area shown in FIG. 16 is measured, and a result of measurement is shown in FIG. 32. A horizontal axis represents a position on a straight light passing through the center of a light receiving area, and the center of the horizontal axis represents a point of center. A vertical axis represents intensity of stray light. A solid line of a graph designates an intensity distribution of stray light achieved in the hologram element of the fourth embodiment. FIG. 32 shows an intensity distribution of stray light, by a dotted line, on condition that the hologram element does not have a third region and is made up of the first region (the first-order diffraction efficiency of about 95%) and the second region (the first-order diffraction efficiency of about 0%); that the second region has a diameter of about 1 mm; and that other conditions for transmissivity are identical. As a result of the hologram element being disposed as mentioned above, the stray light arriving at the photodetector can be diminished. Wraparound of stray light on the photodetector is reduced by making changes in first-order diffraction efficiency (transmissivity) smooth stepwise as in the fourth embodiment. As a result of use of first-order diffracted light, the optical element does not undergo leakage of transmitted light (the 0^{th}-order diffracted light). Hence, an optical head device involving few interference of light from a target layer with light from another layer is obtained.

### INDUSTRIAL APPLICABILITY

As mentioned above, the optical head device of the present invention can efficiently reduce the quantity of stray light originating in a light receiving area of a photodetector by means of a multilayer optical disk, by arranging an optical element, such as an optical attenuation device or a hologram element, in an optical path from the multilayer optical disk, where light undergoes reflection, to the photodetector. Therefore, the optical head device can reduce the influence of crosstalk resultant from signal light and hence is useful.

1. An optical head device comprising:
a light source;
an objective lens that converges outgoing light from the light source on an information recording plane of an optical disk;
a photodetector having a plurality of light-receiving areas for detecting signal light reflected from the information recording plane of the optical disk; and
an optical element that is disposed in an optical path for signal light traveling from the optical disk to the photodetector and that has a function of permitting passage of the signal light or diffracting the signal light through an incidence plane while reducing a quantity of light, wherein
an effective region of the optical element where at least the signal light enters is divided into a first region, a second region, and a third region;
an outer edge of the second region is located at an interior position where the outer edge does not contact an outer edge of the third region or at an interior position where the outer edge contacts a portion of the outer edge of the third region;
an outer edge of the third region is located at an interior position where the outer edge does not contact an outer edge of the first region or at an interior position where the outer edge contacts a portion of the outer edge of the first region;
provided that a ratio of light entering the photodetector to the signal light entering the optical element is taken as transmissivity, when transmissivity of the signal light achieved in the first region is T1 and when transmissivity of the signal light achieved in the second region is T2, T1 is greater than T2;
transmissivity of the signal light achieved in the third region is smaller than T1 and greater than T2; and
at least a portion of a luminous flux of stray light that is resultant of convergence of light from the light source and that is guided to the photodetector upon reflection from a plane of an optical disk differing from the information recording plane, enters the second region of the optical element, thereby diminishing a quantity of stray light arriving at least a portion of the light receiving areas of the photodetector.

2. The optical head device according to claim 1, wherein when transmissivity of the signal light achieved in the third region of the optical element is uniform T3, a difference between T1 and T3 of an optical attenuation device and a difference between T3 and T2 of the optical element ranges from over 0% to 60%.

3. The optical head device according to claim 1, wherein the third region is divided into “m” regions R1 to Rm (an integer of m≧2);
an outer edge of the region Rm is located at an interior position where the outer edge does not contact the outer edge of the first region or the interior position where the outer edge contacts a portion of the outer edge of the first region;
when “x” is taken as an integer ranging from 2 to “m,” an outer edge of a region Rx−1 is located at an interior position where the outer edge does not contact an outer edge of the region Rx or at an interior position where the outer edge contacts a portion of the outer edge of the region Rx−1;
an outer edge of the second region is located at an interior position where the outer edge does not contact an outer edge of the region R1 or an interior position where the outer edge contacts a portion of the outer edge of the region Rx; and
when transmissivity of the signal light undergoing passage or diffraction through or in the region R1, the region R2, . . . , the region Rm is taken as Tr1, Tr2, . . . , Trm, respectively, there stands a relationship of Tr1<Tr2< . . . <Trm.

4. The optical head device according to claim 3, wherein a difference between T1 and Trm of the optical element, a difference between Trx and Trx−1 of the optical element, and a difference between Tr1 and Tr2 of the optical element range from over 0% to 40%.

5. The optical head device according to claim 1, wherein the optical element is an optical attenuation device having a function of letting the signal light pass in a rectilinear direction while reducing a quantity of the light.

6. The optical head device according to claim 5, wherein at least: the second region and the third region of the optical attenuation device include an optical multilayer film or a cholesteric liquid crystal layer that reduces a quantity of the entering signal light.

7. The optical head device according to claim 5, wherein at least the second region and the third region of the optical attenuation device include a diffraction grating structure that reduces rectilinearly-traveling light by diffracting the entering signal light.

8. The optical head device according to claim 1, wherein the optical element includes a modulation element that changes at least a portion of polarized state of the incident light and a polarizer that are arranged in sequence along a traveling direction of incident light;
the polarizer that causes the light of first polarized state to pass and that blocks light of second polarized state orthogonal to the first polarized state;
and
light exiting from the first region passes through the polarizer after having been changed to light of first polarized state by the modulation element, light exiting from the second region does not pass through the polarizer as a result of being brought into the second polarized state by the modulation element, and light exiting from the third region is brought by the modulation element into a state where the first polarized state and the second polarized state are mixed whereby only light of the first polarized state is caused to pass.

9. The optical head device according to claim 1, wherein the optical element is a hologram element having a function of diffracting at least a portion of signal light reflected from the optical disk; the first region has a diffraction grating that diffracts the signal light; the photodetector is arranged in a direction in which the signal light entering the first region is diffracted; and a ratio of the signal light received by the photodetector to the signal light entering the hologram element is taken as transmissivity.

10. The optical head device according to claim 9, further comprising a diffraction element that diffracts a portion of outgoing light from the light source, to thus generate one main beam and two sub-beams; and
the second region includes a beam of stray light that arrives at least a sub-beam light receiving area of the photodetector.

11. The optical head device according to claim 10, wherein an effective area by way of which the main beam of the signal light enters the hologram element includes the first region and the second region, and an optical axis of the main beam is included in the second region.

12. The optical head device according to claim 10, wherein a traveling direction of the signal light exiting from the second region differs from a direction of the photodetector, and the transmissivity T2 substantially comes to zero.

13. The optical head device according to claim 9, wherein the optical element is a hologram element having a function of diffracting at least a portion of signal light reflected, in the form of a single beam, from the optical disk;
a photodetector arranged in a traveling direction of diffracted light of the largest quantity of outgoing light resultant from diffraction of the signal light entering the first region of the hologram element is taken as a first photodetector, and a ratio of light received by the first photodetector is taken as transmissivity.

14. The optical head device according to claim 13, wherein a traveling direction of the signal light exiting from the second region differs from the direction of the first photodetector, and the transmissivity T2 substantially comes to zero.

15. The optical head device according claim 13, wherein the signal light entering the second region rectilinearly travels and exits.

16. The optical head device according to claim 13, wherein a photodetector arranged in a traveling direction of rectilinearly-passed light or diffracted light of the largest quantity of the light exiting from the second region is taken as a second photodetector; and the first photodetector and the second photodetector receive the signal light.

17. The optical head device according to claim 13, wherein, in the hologram element, an effective region by way of which the signal light enters the hologram element is divided into the first region, the second region, the third region, the fourth region, and the fifth region;
an outer edge of the first region is located at an interior position where the outer edge does not contact an outer edge of the fifth region or at an interior position where the outer edge contacts a portion of the outer edge of the fifth region;
the outer edge of the fifth region is located at an interior position where the outer edge does not contact an outer edge of the fourth region or at an interior position where the outer edge contacts a portion of the outer edge of the fourth region;
the first region, the third region, the fourth region, and the fifth region have diffraction gratins for diffracting at least a portion of the signal light;
a photodetector arranged in a traveling direction of light of the largest quantity achieved in a direction differing from traveling directions toward the first photodetector and the second photodetector, among outgoing light beams resultant from diffraction of the signal light entering the fourth region of the hologram element, is taken as a third photodetector;
provided that ratios of the signal light arriving at the first photodetector to the signal light entering the first through fifth regions of the hologram element are taken as T1, T2, T3, T4, and T5, there stand
T1>T3>T2,
T1≧T5≧T4;
provided that ratios of the signal light arriving at the third photodetector to the signal light entering the first through fifth regions of the hologram element are taken as T1′, T2′, T3′, T4′, and T5′, there stands
T4′>T5′>T1′≧T3′≧T2′; and
at least a portion of a luminous flux of stray light, which is guided to the photodetector upon reflection from a plane of the optical disk differing from the information recording plane on which light from the light source is converged, enters the second region of the hologram element.

18. The optical head device according to claim 9, wherein the diffraction grating structure of the hologram element includes at least a structure of blaze shape.

19. The optical head device according to claim 9, wherein the diffraction grating of the hologram element is made of a birefringent material exhibiting refractive anisotropy and an isotropic material exhibiting a refractive index substantially equal to an ordinary refractive index or an extraordinary refractive index of the birefringent material.
